(19) United States
(12) Patent Application Publication
(10) Pub. No.: US 2012/0069593 A1
(43) Pub. Date: Mar. 22, 2012

(54) VEHICLE HEADLAMP AND ILLUMINATION DEVICE

(75) Inventors: Katsuhiko KISHIMOTO, Osaka (JP); Akira Takahashi, Osaka (JP)

(73) Assignee: Sharp Kabushiki Kaisha, Osaka-shi (JP)

(21) Appl. No.: 13/239,051

(22) Filed: Sep. 21, 2011

(30) Foreign Application Priority Data
Sep. 21, 2010 (JP) 2010-210628
Sep. 16, 2011 (JP) 2011-202504

(51) Int. Cl. B60Q 1/00; F21V 29/00; F21V 7/00

(52) U.S. Cl. 362/511; 362/514; 362/280

(57) ABSTRACT

A headlamp includes: a laser diode for emitting a laser beam; a light-emitting section for emitting light by being excited by a laser beam emitted from the laser diode; a reflection mirror for reflecting the light emitted from the light-emitting section so as to form a bundle of rays which travel within a predetermined solid angle; and a first maneuvering section for maneuvering at least the reflection mirror so as to move an optical axis direction of the light reflected by the reflection mirror to a predetermined direction.

This Nonprovisional application claims priority under 35 U.S.C. §119(a) on Patent Application No. 2010-210628 filed in Japan on Sep. 21, 2010 and Patent Application No. 2011-202504 filed in Japan on Sep. 16, 2011, the entire contents of which are hereby incorporated by reference.

### TECHNICAL FIELD

The present invention relates to a vehicle headlamp and an illumination device each of which has a high-luminance light source, and can allow an object (maneuvering object) that is maneuvered in optical axis adjustment, to have an improved responsivity to the optical axis adjustment.

### BACKGROUND ART

In a case where an optical axis of a vehicle headlamp is directed upward due to an inclination of an automobile body, a person in an oncoming vehicle is dazzled by light from the vehicle headlamp. On the other hand, in a case where the optical axis direction of the vehicle headlamp is directed downward, a distant visibility of a driver is decreased. In response to such a demand, optical axis adjusting apparatuses (automatic leveling apparatuses) have been developed which carry out optical axis adjustment so as to keep automatically constant leveling of an optical axis. Such optical axis adjusting apparatuses are disclosed in, e.g., Patent Literatures 1 through 3.

Patent Literature 1 discloses a technique for adjusting an optical axis so that the optical axis accords with (i) a rolling (lateral postural change) of an automobile body of the vehicle driving on a curved road or the like and (ii) a slope of a road surface. Further, as a technique to prevent waste of electricity and shortening a life of an apparatus, Patent Literature 2 discloses a technique for carrying out optical axis adjustment in accordance with (i) an operating state of a power source (e.g., engine) of a vehicle or (ii) a running state of the vehicle, and in accordance with (I) whether or not a headlamp is instructed to light up or (II) a lighting state of the headlamp. Further, as a technique for improving a headlamp in responsivity of its movement to optical axis adjustment, Patent Literature 3 discloses a technique for optical axis adjustment in which filters for changing the responsivity of the headlamp to the optical axis adjustment are switched so as to select a filter in accordance with a driving state, and then, an angle is obtained by use of the selected filter so that optical axis adjustment is carried out on the basis of the angle.

Further, Public Notice Specifying Details of Safety Standards for Road Vehicles (Feb. 26, 2009), Appendix 52 (Technical Standards for Installed devices: Lamps and Reflectors, and indicators) provides that (i) a passing headlamp (headlamp for driving against each other on opposite lanes) which has a light source whose luminous flux is more than 2000 lm (lumen) (e.g., HID (High Intensity Discharge) lamp) or (ii) a passing headlamp which has an LED module for generating a main low beam shall have an automatic headlamp irradiation direction adjusting apparatus. The automatic headlamp irradiation direction adjusting apparatus adjusts the irradiation direction along a direction perpendicular to the ground (i.e., along an up-and-down direction).

### CITATION LIST

Patent Literature 1
Japanese Patent Application Publication, Tokukaihei, No. 6-144108 A (Publication Date: May 24, 1994)

Patent Literature 2
Japanese Patent Application Publication, Tokukaihei, No. 9-290683 A (Publication Date: Nov. 11, 1997)

Patent Literature 3
Japanese Patent Application Publication, Tokukaihei, No. 10-166933 A (Publication Date: Jun. 23, 1998)

### SUMMARY OF INVENTION

### Technical Problem

According to Patent Literatures 1 through 3, the headlamp which includes a light source is maneuvered as a whole in the optical axis adjustment. Particularly, in a case where an LED light source is employed, the headlamp becomes large and heavy because a plurality of LED modules are required for achieving a sufficient brightness. For this reason, in some cases, it is difficult to maneuver the headlamp so that the movement of headlamp quickly follows the optical axis adjustment. That is, the conventional techniques have a possibility that a maneuvering object (conventionally the whole headlamp) to be maneuvered in optical axis adjustment has a low responsivity (responsive followability) to the optical axis adjustment.

The present invention was made in view of the problem. An object of the present invention is to provide a vehicle headlamp which makes it possible that a maneuvering object which is maneuvered in optical axis adjustment can be maneuvered with an improved responsivity to the optical axis adjustment.

### Solution to Problem

In order to attain the object, a vehicle headlamp and an illumination device of the present invention include an excitation light source for emitting excitation light; a light-emitting section for receiving the excitation light emitted from the excitation light source, and emitting light by being exited by the excitation light; a reflection mirror for reflecting the light emitted from the light-emitting section so as to form a bundle of rays which travel within a predetermined solid angle; and a first maneuvering section for maneuvering at least the reflection mirror so as to move an optical axis direction of the light reflected by the reflection mirror to a predetermined direction.

According to the arrangement, the headlamp and the illumination device with a high luminance can be realized by including the excitation light source for emitting excitation light, and the light-emitting section for emitting light in response to the excitation light emitted from the excitation light source. Accordingly, the present invention can have a smaller light-emitting section than, e.g., a light-emitting section (light source) of the conventional headlamp in a case where the headlamp or the illumination device emits light having a predetermined luminous flux (e.g., a luminous flux within a legally-stipulated range). As a result, the vehicle headlamp and the illumination device of the present invention can be designed to be small in size and weight. That is, the reflection mirror can also be designed to be small in size and lighter in weight.

Further, the headlamp and the illumination device of the present invention include the first maneuvering section which maneuvers at least the reflection mirror so as to move an optical axis direction of the bundle of rays formed by the reflection mirror to the predetermined direction. In a case where the vehicle headlamp or the illumination device of the present invention carries out optical axis adjustment so that the optical axis direction matches the predetermined direction, the first maneuvering section maneuvers at least the reflection mirror of the vehicle headlamp or the illumination device of the present invention which vehicle headlamp and illumination device are designed to be, e.g., smaller in size and lighter in weight than, e.g., conventional headlamps. This allows a maneuvering object which is maneuvered in optical axis adjustment (at least the reflection mirror) to have an improved responsivity to the optical axis adjustment, as compared to the conventional headlamps.

### Advantageous Effects of Invention

As described above, a vehicle headlamp and an illumination device of the present invention includes: an excitation light source for emitting excitation light; a light-emitting section for receiving the excitation light emitted from the excitation light source, and emitting light by being exited by the excitation light; a reflection mirror for reflecting the light emitted from the light-emitting section so as to form a bundle of rays which travel within a predetermined solid angle; and a first maneuvering section for maneuvering at least the reflection mirror so as to move an optical axis direction of the light reflected by the reflection mirror to a predetermined direction.

This makes it possible that a maneuvering object can be maneuvered in optical axis adjustment with an improved responsivity to the optical axis adjustment.

### BRIEF DESCRIPTION OF DRAWINGS

FIG. 1 is a view illustrating a schematic arrangement of a headlamp of one embodiment of the present invention, specifically, a perspective view illustrating a schematic arrangement encompassing the optical axis adjustment mechanisms for adjusting an optical axis of light emitted from the headlamp.

FIG. 2 is a cross-sectional view illustrating an arrangement of the headlamp of the one embodiment of the present invention.

FIG. 3 is a view illustrating a positional relationship between a light-emitting section and emission end sections of optical fibers of the headlamp of the one embodiment of the present invention.

FIG. 4 is a view illustrating an arrangement of a laser diode of the headlamp of the one embodiment of the present invention. (a) of FIG. 4 is a view schematically illustrating a circuit of the laser diode. (b) of FIG. 4 is a perspective view illustrating a basic structure of the laser diode.

FIG. 5 is a view illustrating a schematic arrangement of the headlamp of the one embodiment of the present invention. (a) of FIG. 5 is a schematic view illustrating the headlamp from its lateral side. (b) of FIG. 5 is a schematic view illustrating the headlamp from above.

FIG. 6 is a view illustrating how optical axis adjustment of the headlamp of the one embodiment of the present invention is carried out. (a) of FIG. 6 is a schematic view illustrating the headlamp from its lateral side for a case where optical axis adjustment is carried out upward with respect to a reference line. (b) of FIG. 6 is a schematic view illustrating the headlamp from its lateral side for a case where optical axis adjustment is carried out downward with respect to the reference line.

FIG. 7 is a view illustrating an internal arrangement of a first maneuvering section of the headlamp of the one embodiment of the present invention.

FIG. 8 is a block diagram illustrating a schematic arrangement of an automobile having the headlamp of the one embodiment of the present invention.

FIG. 9 is a flowchart showing a flow of optical axis adjustment of the headlamp of the one embodiment of the present invention.

FIG. 10 is a view illustrating a schematic arrangement of a headlamp of another embodiment of the present invention, specifically, a perspective view illustrating a schematic arrangement of a headlamp including a sectorial light guide section.

FIG. 11 is a view illustrating how the first maneuvering section of the headlamp of the another embodiment maneuvers the reflection mirror. (a) of FIG. 11 is a view illustrating the headlamp facing right front. (b) of FIG. 11 is a view illustrating the headlamp maneuvered to face upward from the reference line. (c) of FIG. 11 is a view illustrating the headlamp maneuvered to face downward from the reference line.

FIG. 12 is a view illustrating a schematic arrangement of a headlamp of another embodiment of the present invention, specifically, a perspective view illustrating a schematic arrangement encompassing optical axis adjustment mechanisms for adjusting an optical axis of light emitted from the headlamp.

FIG. 13 is a view illustrating an internal arrangement of a second maneuvering section of a headlamp of another embodiment of the present invention.

FIG. 14 is cross-sectional view illustrating a schematic arrangement of a headlamp of another embodiment of the present invention.

FIG. 15 is a view illustrating a positional relationship between a light-emitting section and emission end sections of optical fibers of the headlamp of the another embodiment of the present invention.

FIG. 16 is a view illustrating how the first maneuvering section of the headlamp of the another embodiment maneuvers the reflection mirror. (a) of FIG. 16 is a view illustrating the headlamp facing right front. (b) of FIG. 16 is a view illustrating the headlamp maneuvered to face upward from the reference line. (c) of FIG. 16 is a view illustrating the headlamp maneuvered to face downward from the reference line.

FIG. 17 is a perspective view illustrating a schematic arrangement of a headlamp of another embodiment of the present invention.

### DESCRIPTION OF EMBODIMENTS

### First Embodiment

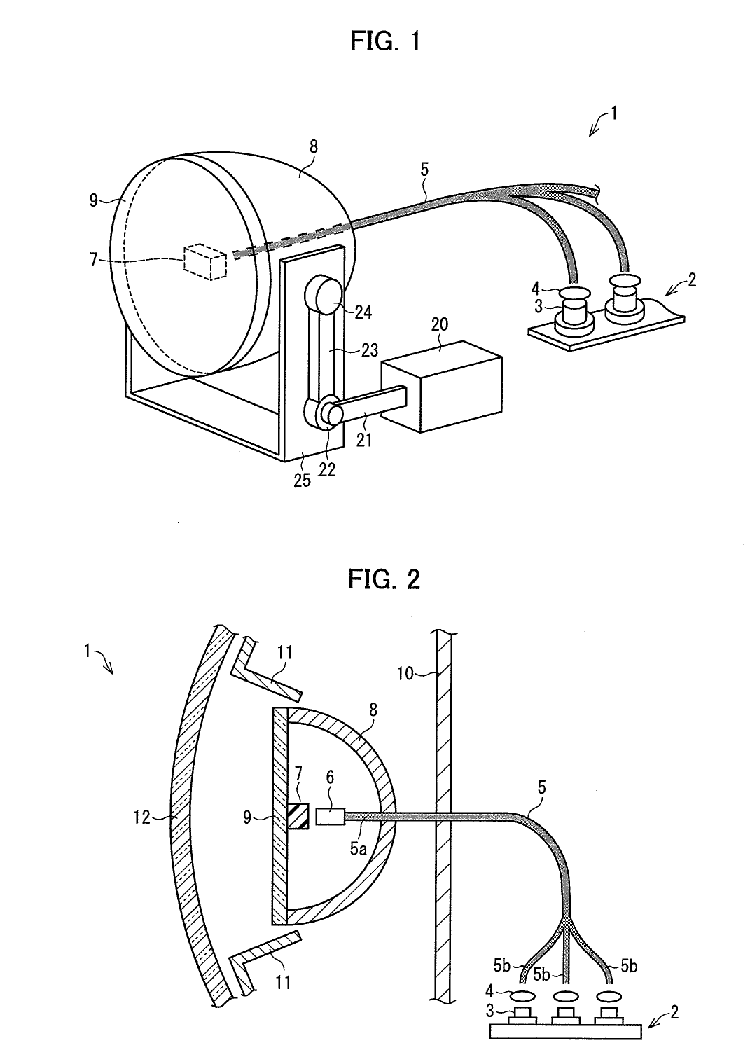

The following describes one embodiment of the present invention, with reference to FIGS. 1 through 9. The following deals with a headlamp 1 for an automobile (vehicle headlamp) as one example of an illumination device of the present invention. The illumination device of the present invention can alternatively be used as a headlamp for a vehicle or moving object other than an automobile (for example, a human, a vessel, an airplane, a submersible vessel, or a rocket).

The headlamp 1 can meet either a light distribution property standard for a driving headlamp (high beam) or a light distribution property standard for a passing headlamp (low beam).

(Arrangement of Headlamp 1)

FIG. 2 is a cross-sectional view illustrating an arrangement of the headlamp 1. As illustrated in FIG. 1, the headlamp 1 includes: a laser diode array (excitation light source) 2; aspheric lenses 4; an optical fiber (light guide section) 5; a ferrule 6; a light-emitting section 7; a reflection mirror 8; a transparent plate 9; a housing 10; an extension 11; and a lens 12. A basic structure of a light-emitting device is made up of the laser diode array 2, the optical fiber 5, the ferrule 6, and the light-emitting section 7.

The headlamp 1 of the present embodiment includes optical axis adjustment mechanisms (first maneuvering section 20 etc. to be described later) for adjusting an optical axis (optical axis direction) of light emitted from the headlamp 1. Details of the optical axis adjustment mechanisms are described later. The following first deals with an arrangement of the headlamp 1 except the optical axis adjustment mechanisms.

The laser diode array 2 includes a plurality of laser diodes (laser diode elements, excitation light sources) 3 on a substrate, and functions as an excitation light source for emitting excitation light. The laser diodes 3 individually emit laser beams. The excitation light source not necessarily includes a plurality of laser diodes 3, and can thus alternatively include a single laser diode 3. However, the use of a plurality of laser diodes 3 makes it possible to obtain a high-power laser beam more easily.

The plurality of laser diodes 3 each include a single light-emitting point on a single chip, and are each contained in a package having a diameter of 5.6 mm. The plurality of laser diodes 3 each (i) emit a laser beam of, for example, 405 nm (blue-violet light) and (ii) have an output power of 1.0 W, an operating voltage of 5 V, and an operating current of 0.6 A. The plurality of laser diodes 3 each not necessarily emit a laser beam of 405 nm, and can thus alternatively emit any laser beam that has a peak wavelength within a range from 380 nm to 490 nm. The plurality of laser diodes 3 of the present embodiment can each alternatively be a laser diode designed to emit a laser beam having a wavelength shorter than 380 nm if it is possible to produce a laser diode for a short wavelength which laser diode (i) emits a laser beam having a wavelength shorter than 380 nm and yet (ii) has high quality.

Further alternatively, the plurality of laser diodes 3 can each include a plurality of light-emitting points on a single chip.

The aspheric lenses 4 each function to cause a laser beam (excitation light) emitted from a laser diode 3 to enter an end of the optical fiber 5, that is, an entrance end section 5b. The aspheric lenses 4 can each include, for example, a FLKN1 405 available from ALPS ELECTRIC Co., Ltd. The aspheric lenses 4 are each not particularly limited in shape or material, provided that the aspheric lenses 4 each include a lens having the above function. The aspheric lenses 4 are, however, preferably each made of a material which has (i) a high transmittance for a wavelength of approximately 405 nm which is a wavelength of the excitation light and (ii) a high heat resistance.

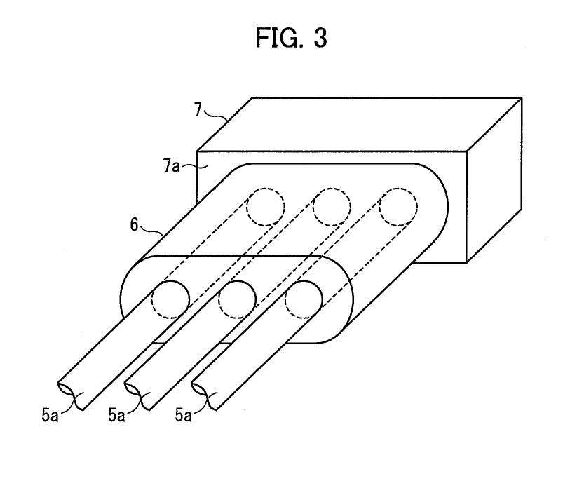

The optical fiber 5 includes a bundle of a plurality of optical fibers, and thus serves as a light guide member for guiding a laser beam from each laser diode 3 through to the light-emitting section 7. The optical fiber 5 includes: a plurality of entrance end sections 5b each for receiving a laser beam emitted from a laser diode 3; and a plurality of emission end sections 5a each for emitting a laser beam received by an entrance end section 5b. The plurality of emission end sections 5a emit their respective laser beams to different regions on a laser beam-irradiated surface (light-receiving surface) 7a (see FIG. 3) of the light-emitting section 7. To be more specific, the plurality of emission end sections 5a emit laser beams in such a way that light with the highest intensity in light intensity distribution of each of the laser beams is emitted to different regions of the light-emitting section 7 (laser beam-irradiated surface 7a). The plurality of emission end sections 5a may have contact with the laser beam-irradiated surface 7a, or may be positioned at a small distance from the laser beam-irradiated surface 7a. In other words, the optical fiber 5 is for receiving the laser beams emitted from the laser diodes 3 and emitting the laser beams to the light-emitting section 7.

The plurality of optical fibers included in the optical fiber 5 each have a double-layered structure in which a center core is coated with a clad having a refractive index lower than that of the core. The core includes a quartz glass (silicon oxide) as a main component which quartz glass hardly causes an absorption loss of a laser beam. The clad includes, as a main component, either a quartz glass or a synthetic resin material each of which has a refractive index lower than that of the core. For example, the plurality of optical fibers of the optical fiber 5 are made of quartz, each include a core having a diameter of 200 μm and a clad having a diameter of 240 μm, and each have a numerical aperture NA of 0.22. The plurality of optical fibers of the optical fiber 5 are not limited in structure, thickness, or material to the above example. The plurality of optical fibers of the optical fiber 5 can, for example, each alternatively have a rectangular cross section perpendicular to its longer axis direction.

The aspheric lenses 4 and the optical fiber 5 have an optical connection efficiency (i.e., a light intensity of the laser beams to be emitted from the emission end sections 5a of the optical fiber 5 in a case where an intensity of the laser beams emitted from the laser diodes 3 is 1) of 90%.

The light guide member can alternatively include (i) a member other than an optical fiber or (ii) a combination of an optical fiber and another member. The light guide member is simply required to include (i) at least one entrance end section for receiving a laser beam emitted from a laser diode 3 and (ii) a plurality of emission end sections each for emitting a laser beam received by the entrance end section. For example, the light guide member can alternatively be arranged such that (i) it includes, separately from an optical fiber, an entrance section having at least one entrance end section and an emission section having a plurality of emission end sections and that (ii) the entrance section and the emission section are connected to the optical fiber at its opposite ends.

FIG. 3 is a view illustrating the positional relationship between the plurality of emission end sections 5a and the light-emitting section 7. As illustrated in FIG. 3, the ferrule 6 supports the plurality of emission end sections 5a of the optical fiber 5 in a predetermined pattern with respect to the laser beam-irradiated surface 7a of the light-emitting section 7. The ferrule 6 can have holes in a predetermined pattern in which holes the plurality of emission end sections 5a are inserted. The ferrule 6 can alternatively be arranged such that (i) it includes an upper portion and a lower portion which are separable from each other and each of which has grooves formed on its joining surface, and that (ii) the upper portion and the lower portion sandwich the plurality of emission end sections 5a so that the plurality of emission end sections 5a are supported in respective holes formed by the grooves.

The ferrule 6 is simply required to be fixed relative to the reflection mirror 8 with use of, for example, a bar-shaped or tube-shaped member which extends from the reflection mirror 8. The ferrule 6 is not particularly limited in terms of material, and is made of stainless steel, for example. The ferrule 6 can be replaced with a plurality of ferrules 6 provided relative to a single light-emitting section 7. FIG. 3 illustrates three emission end sections 5a for convenience of explanation. The number of the plurality of emission end sections 5a is, however, not limited to three.

The light-emitting section 7 is provided in the vicinity of a focal point of the reflection mirror 8, and emits light in response to a laser beam emitted from an emission end section 5a. The light-emitting section 7 contains a fluorescent substance which emits light in response to a laser beam. In other words, the light-emitting section 7 has the laser beam-irradiated surface 7a which receives the laser beams emitted from the optical fiber 5. Specifically, the light-emitting section 7 includes a fluorescent substance dispersed in inorganic glass serving as a fluorescent material supporting material. The inorganic glass and the fluorescent substance are present in a ratio of approximately 10:1. The light-emitting section 7 can alternatively be made of a fluorescent substance pressed together. The fluorescent substance supporting material is not limited to inorganic glass but may be organic or inorganic hybrid glass, or silicone resin.

The fluorescent substance is an oxynitride light-emitting material or a nitride light-emitting material, and includes blue, green, and red fluorescent substances for dispersion in inorganic glass. The light-emitting section 7 emits white light in response to a 405-nm laser beam (blue-violet light) emitted from each of the plurality of laser diodes 3. The light-emitting section 7 thus functions as a wavelength converting material.

The plurality of laser diodes 3 can each alternatively serve to emit a laser beam having a wavelength of 450 nm (blue light) or a laser beam having a wavelength close to the wavelength for blue light, that is, a laser beam having a peak wavelength which falls within a range from 440 nm to 490 nm. In this case, the above fluorescent substances include (i) a yellow fluorescent substance or (ii) a mixture of a green fluorescent substance and a red fluorescent substance. In other words, the plurality of laser diodes 3 can each alternatively emit excitation light having a peak wavelength within a range from 440 nm to 490 nm. With this arrangement, it is possible to easily select and produce a material (fluorescent substance) for the light-emitting section 7 which material is used to emit white light. A yellow fluorescent substance emits light having a peak wavelength which falls within a range from 560 nm to 590 nm. A green fluorescent substance emits light having a peak wavelength which falls within a range from 510 nm to 560 nm. A red fluorescent substance emits light having a peak wavelength which falls within a range from 600 nm to 680 nm.

The above fluorescent substance can be a fluorescent substance commonly referred to as (i) a nitride fluorescent substance or (ii) an oxynitride fluorescent substance (SiAlON fluorescent substance). SiAlON fluorescent substance is a material in which the silicon atoms and nitrogen atoms in silicon nitride are partially substituted with aluminum atoms and oxygen atoms, respectively. SiAlON fluorescent substance can be prepared by making a solid solution of, for example, silicon nitride (Si₃N₄), alumina (Al₂O₃), silica (SiO₂), and a rare earth.

Another preferable example of the fluorescent substance is semiconductor nanoparticle fluorescent substance made of nanometer-size III-V compound semiconductor particles. Semiconductor nanoparticle fluorescent substance has a characteristic that even in a case where they are made of a single compound semiconductor (for example, indium phosphide [InP]), it is possible to change a color of emission light with use of a quantum size effect caused by changing a particle diameter of the semiconductor nanoparticle fluorescent substance. For example, semiconductor nanoparticle fluorescent substance made of InP emits red light in a case where they each have a particle size which falls within a range approximately from 3 nm to 4 nm. The particle size was measured by use of a transmission electron microscope (TEM).

Further, the semiconductor nanoparticle fluorescent substance is a semiconductor-based one. Accordingly, the semiconductor nanoparticle fluorescent substance has a short fluorescence lifetime, and quickly emits a power of excitation light as fluorescence. Semiconductor nanoparticle fluorescent substance thus characteristically tolerates high-power excitation light well. This is because semiconductor nanoparticle fluorescent substance has a light emission lifetime of approximately 10 nanoseconds, which is about 10⁻⁵ times a light emission lifetime of a normal fluorescent substance including a rare earth as a luminescent center. Further, since the semiconductor nanoparticle fluorescent substance has a short fluorescence lifetime, the semiconductor nanoparticle fluorescent substance can quickly repeat a cycle of excitation light absorption and fluorescence emission.

Accordingly, it is possible to maintain high efficiency with respect to intense laser beams, thereby reducing heat emission from the fluorescent materials. This makes it possible to further prevent heat deterioration (discoloration and/or deformation) in a light conversion material. As such, it is possible to further prevent a reduction in a life of a light emitting device in a case where the light emitting device includes, as a light source, a high-power light emitting element.

The light-emitting section 7 has a shape of, for example, a cuboid which is 3 mm×1 mm×1 mm. In this case, the laser beam-irradiated surface 7a for receiving laser beams from the plurality of laser diodes 3 is 3 mm² in area. The laser beam-irradiated surface 7a preferably has an area from 1 to 3 mm². A Japanese law stipulates a light distribution pattern (light distribution) for a vehicle headlamp which light distribution pattern is narrow in an up-and-down direction and wide in a lateral direction. In a case where the light-emitting section 7 is horizontally long (substantially rectangular in a cross section), it is possible to easily achieve the above light distribution pattern. The light-emitting section 7 is not necessarily cuboid, and can thus alternatively be cylindrical so that the laser beam-irradiated surface 7a has a shape of an ellipse. The laser beam-irradiated surface 7a is not necessarily a flat surface, and can thus alternatively be a curved surface.

The laser beam-irradiated surface 7a is, however, preferably a flat surface so as to control reflection of a laser beam. In a case where the laser beam-irradiated surface 7a is a curved surface, light falls upon the curved surface at least at greatly varying angles. Reflected light thus travels in directions which greatly vary according to a location on which a laser beam falls. As such, it may be difficult in such a case to control a reflection direction of a laser beam. In contract, in a case where the laser beam-irradiated surface 7a is a flat surface, reflected light hardly changes its traveling direction even if a slight shift is caused to a location on which a laser beam falls. As such, it is easy in such a case to control a reflection direction of a laser beam. Further, depending on circumstances, it is easy to take a measure such as providing a laser beam absorption member at a location on which reflected light falls.

As illustrated in FIG. 2, the light-emitting section 7 is fixed on an inside surface of the transparent plate 9 (that is, a surface facing the plurality of emission end sections 5a) at such a location as to face the plurality of emission end sections 5a. How and where the light-emitting section 7 is fixed is, however, not limited to this. The light-emitting section 7 can alternatively be fixed with use of a bar-shaped or tube-shaped member which extends from the reflection mirror 8.

The reflection mirror 8 has an opening. The reflection mirror 8 reflects light emitted from the light-emitting section 7. The reflection mirror 8 thus forms a bundle of rays traveling within a predetermined solid angle, and consequently emits the bundle of rays from the opening. In other words, the reflection mirror 8 reflects light from the light-emitting section 7 so as to form a bundle of rays traveling in a forward direction in which the headlamp 1 faces. The reflection mirror 8 is, for example, a member which has a curved surface (in a shape of a cup) and which is provided with a metal thin film on a surface thereof.

The reflection mirror 8 is not limited to a hemispherical mirror. The reflection mirror 8 can thus alternatively be an ellipsoidal mirror, a parabolic mirror, or a mirror which has an ellipsoidal or parabolic portion. In other words, the reflection mirror 8 is simply required to include, in its reflection surface, at least a portion having a curved surface formed by rotating a shape (an ellipse, a circle, or a parabola) about a rotation axis.

The transparent plate 9 is a transparent resin plate which covers the opening of the reflection mirror 8. The transparent plate 9 holds the light-emitting section 7. The transparent plate 9 is preferably made of a material which blocks laser beams from the plurality of laser diodes 3 and which transmits white light generated by conversion of the laser beams by the light-emitting section 7. Although a coherent laser beam is mostly converted by the light-emitting section 7 into incoherent light, such a coherent laser beam may not entirely converted into incoherent light for some reason. Even in such a case, since the transparent plate 9 blocks laser beams, it is possible to prevent the laser beams from leaking out. The transparent plate 9 can alternatively be omitted if the above effect is unnecessary and the light-emitting section 7 is held by a member other than the transparent plate 9.

The housing 10 is a part of a body of the headlamp 1, and contains members such as the reflection mirror 8. The housing 10 is penetrated by the optical fiber 5. The above laser diode array 2 is provided outside the housing 10. The laser diode array 2, which generates heat when emitting laser beams, is provided outside the housing 10 as above so as to be cooled efficiently. Further, in case that a laser diode 3 breaks down, the laser diode array 2 is preferably provided at such a location as to facilitate replacement of such a broken laser diode 3. The laser diode array 2 can be contained in the housing 10 if the above advantages are unnecessary.

The extension 11 is provided at a location away from the reflection mirror 8 in the forward direction so as not to overlap the opening of the reflection mirror 8. The extension 11 hides an inner structure of the headlamp 1 so as to (i) improve appearance of the headlamp 1 and (ii) improve accordance between the reflection mirror 8 and an automobile body. The extension 11 is, like the reflection mirror 8, a member provided with a metal thin film on a surface thereof.

The lens 12 is provided at an opening of the housing 10 so as to seal the headlamp 1. Light emitted from the light-emitting section 7 and reflected from the reflection mirror 8 travels through the lens 12 in the forward direction in which the headlamp 1 faces.

Thus, the headlamp 1 is arranged such that laser beams emitted from the plurality of emission end sections 5a provided horizontally to the laser beam-irradiated surface 7a travel in a dispersed manner so that the laser beam-irradiated surface 7a is irradiated with the laser beams. This makes it possible to efficiently excite low-energy electrons of the whole fluorescent substance contained in the light-emitting section 7 so that the low-energy electrons have high energy. The present embodiment makes it possible to realize a headlamp 1 which achieves a high luminance and a high luminous flux. Specifically, light emitted from the light-emitting section 7 has a luminous flux of approximately 2000 lm, and a luminance of the light-emitting section 7 is 100 cd/mm². Further, the present embodiment makes it possible to realize a small lightweight headlamp 1.

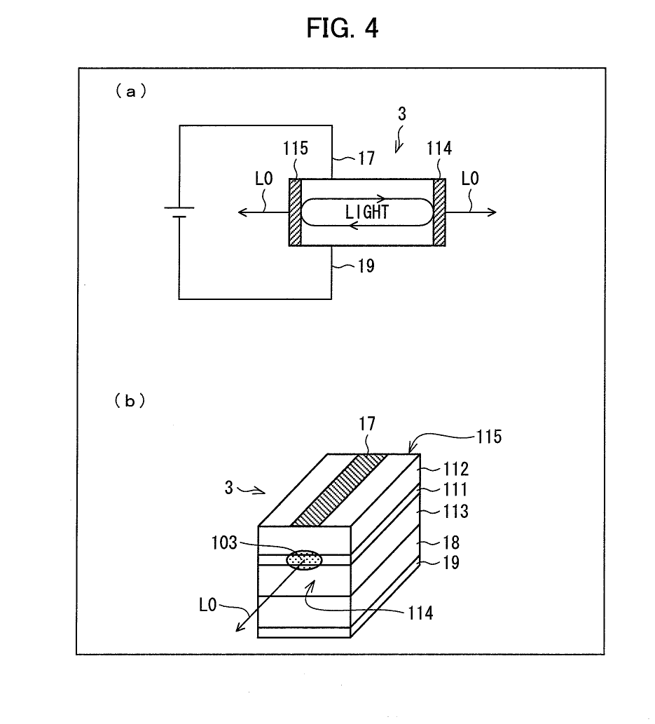

The following description deals with a basic structure of a laser diode 3. (a) of FIG. 4 is a view schematically illustrating a circuit of the laser diode 3. (b) of FIG. 4 is a perspective view illustrating the basic structure of the laser diode 3. As illustrated in (b) of FIG. 4, the laser diode 3 includes: a cathode electrode 19; a substrate 18; a clad layer 113; an active layer 111; a clad layer 112; and an anode electrode 17. These members are stacked on one another in that order.

The substrate 18 is a semiconductor substrate. The substrate 18 is preferably made of GaN, sapphire, or SiC so that the laser diode 3 can, as in the present invention, emit excitation light within blue to ultraviolet ranges for exciting fluorescent substance. A substrate for use in a laser diode is typically made of, other than the above examples, any one of (i) IV semiconductors such as Si, Ge, and SiC, (ii) III-V compound semiconductors such as GaAs, GaP, InP, AlAs, GaN, InN, InSb, GaSb, and AlN, (iii) II-VI compound semiconductors such as ZnTe, ZeSe, ZnS, and ZnO, (iv) oxide insulators such as ZnO, Al₂O₃, SiO₂, TiO₂, CrO₂, and CeO₂, and (v) nitride insulators such as SiN.

The anode electrode 17 serves to supply a current to the active layer 111 via the clad layer 112.

The cathode electrode 19 is provided below the substrate 18, and serves to supply a current to the active layer 111 via the clad layer 113. The active layer 111 is supplied with a current as such in response to a forward bias voltage applied between the anode electrode 17 and the cathode electrode 19.

The active layer 111 is sandwiched between the clad layers 112 and 113.

The active layer 111 and the clad layers 112 and 113 are each made of a mixed crystal semiconductor (AlInGaN) so that the laser diode 3 can emit excitation light within the blue to ultraviolet ranges. The active layer 111 and the clad layers 112 and 113 can each alternatively be made of a typical material for an active layer and a clad layer of a laser diode which typical material is a mixed crystal semiconductor primarily constituted by any combination of Al, Ga, In, As, P, N, and Sb. The active layer 111 and the clad layers 112 and 113 can each further alternatively be made of Zn, Mg, S, Se, or Te, or a II-VI compound semiconductor such as ZnO.

The active layer 111 is a region which emits light in response to a supplied current. The light is confined in the active layer 111 due to a difference in refractive index between the clad layers 112 and 113.

The active layer 111 has a front cleaved surface 114 and a rear cleaved surface 115 facing each other so as to confine light amplified by stimulated emission. The front and rear cleaved surfaces 114 and 115 each serve as a mirror.

More specifically, the front and rear cleaved surfaces 114 and 115 each serve not as a mirror which totally reflects light: The light amplified by stimulated emission is partially emitted from the front cleaved surface 114 and the rear cleaved surface 115 of the active layer 111 (only from the front cleaved surface 114 in the present embodiment for convenience of explanation) so as to provide a laser beam (excitation light) L0. Further, the active layer 111 can have a multilayer quantum well structure.

The rear cleaved surface 115 facing the front cleaved surface 114 is provided with a reflection film (not shown) for laser oscillation. Respective reflectances of the front and rear cleaved surfaces 114 and 115 are thus made different from each other so that most of the laser beam L0 is emitted from a low-reflectance end surface (for example, the front cleaved surface 114), specifically from a light-emitting point 103.

The clad layers 112 and 113 are each made of either of (i) a III-V compound semiconductor (for example, GaAs, GaP, InP, AlAs, GaN, InN, InSb, GaSb, or MN) of an n-type or p-type, and (ii) a II-VI compound semiconductor (for example, ZnTe, ZeSe, ZnS, and ZnO) of an n-type or p-type. With this arrangement, it is possible to supply a current to the active layer 111 by applying a forward bias voltage between the anode electrode 17 and the cathode electrode 19.

The semiconductor layers such as the clad layers 112 and 113 and the active layer 111 can each be deposited by a typical film deposition method such as MOCVD (metal-organic chemical vapor deposition), MBE (molecular-beam epitaxy), CVD (chemical vapor deposition), laser ablation, and sputtering. The metal layers can also be deposited by a typical film deposition method such as vacuum deposition, plating, laser ablation, and sputtering.

(Principle of Light Emission of Light-emitting section 7)

The following description deals with a principle on which the fluorescent substance emits light in response to a laser beam emitted from a laser diode 3.

First, a laser diode 3 emits a laser beam which then falls on the fluorescent substance included in the light-emitting section 7. The laser beam excites low-energy electrons present in the fluorescent substance so that they are in a high-energy state (excited state).

Then, since the excited state is unstable, the energy state of the electrons in the fluorescent substance returns to the original low-energy state after a certain period of time. The low-energy state refers to a ground-level energy state or a metastable-level energy state between the excitation level and the ground level.

The fluorescent substance emits light as the high-energy state of the excited electrons returns to the low-energy state as described above.

White light can be generated from (i) a mixture of three colors which meet an isochromatic principle or (ii) a mixture of two colors which meet a complimentary relation with each other. Specifically, white light can be generated from combining, on the basis of the principle and relation, (i) a color of a laser beam emitted from the laser diode and (ii) a color of light emitted from the fluorescent substance.

(Overview of Optical Axis Adjustment)

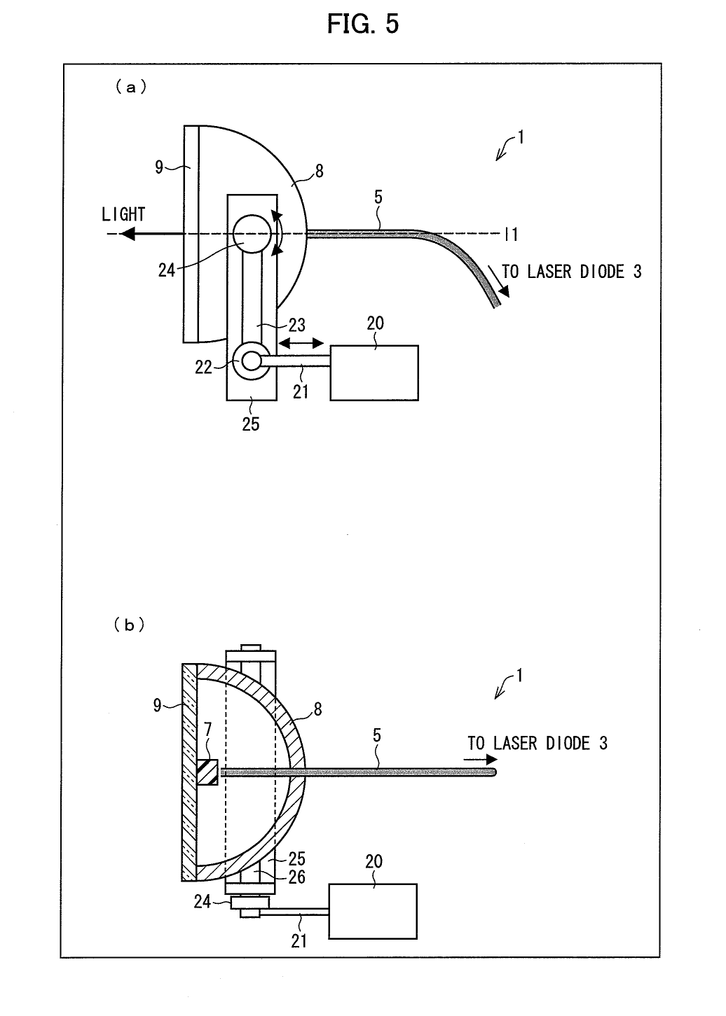

The following describes the optical axis adjustment mechanisms of the headlamp 1, with reference to FIGS. 1, and 5 through 9. FIG. 1 is a view illustrating a schematic arrangement of the headlamp 1, specifically, a perspective view illustrating a schematic arrangement encompassing the optical axis adjustment mechanisms for adjusting an optical axis of light emitted from the headlamp 1. FIG. 5 is a view illustrating a schematic arrangement of the headlamp 1. (a) of FIG. 5 is a schematic view illustrating the headlamp 1 from its lateral side. (b) of FIG. 5 is a schematic view illustrating the headlamp 1 from above. The headlamp 1 and the optical axis adjustment mechanisms thereof make up a headlamp unit.

As illustrated in FIG. 5, the headlamp 1 includes a first maneuvering section 20, a driven section 21, a first shaft section 22, a support 23, a second shaft section 24, and a lamp support 25, in addition to the aforementioned arrangement. FIG. 5 omits to illustrate the ferrule 6. In FIG. 5, the optical fiber 5 is connected with the laser diodes 3 of the laser diode array 2.

Under control of a control section 32 to be described later, the first maneuvering section 20 maneuvers the reflection mirror 8 in an up-and-down direction (upward or downward) so as to move the optical axis direction of the light emitted from the headlamp 1 (i.e., light irradiation direction of the headlamp 1) to a predetermined direction. In other words, the first maneuvering section 20 maneuvers at least the reflection mirror 8 so as to move the optical axis direction of the light reflected by the reflection mirror 8 to the predetermined direction. Further, the first maneuvering section 20 can be described as a member for maneuvering at least the reflection mirror 8 in the up-and-down direction. In order to maneuver the reflection mirror 8 in the up-and-down direction, the first maneuvering section 20 generates a force which is used to move the driven section 21 inserted into the first maneuvering section 20. The force moves the driven section 21 in the optical axis direction obtained in a case where a normal to a surface of the transparent plate 9 faces right front during the halting of the vehicle (this optical axis direction is a direction along a reference line 11 in (a) of FIG. 5, and is hereinafter referred to as “reference direction”).

The driven section 21 is a bar-like member having one end inserted into the first maneuvering section 20 and the opposite end connected with the first shaft section 22. The driven section 21 is driven by the first maneuvering section 20 so as to move in the reference direction.

The first shaft section 22 is a rotary shaft which connects the driven section 21 and the support 23, and is moved in the reference direction in accordance with the movement of the driven section 21.

The support 23 is a bar-like member which connects the first shaft section 22 and the second shaft section 24. The support 23 rotates a rotary shaft of the second shaft section 24 in accordance with the movement of the first shaft section 22 in the reference direction.

The second shaft section 24 is connected with the reflection mirror 8 via a lamp support 25. The rotary shaft of the second shaft section 24 is rotated in accordance with the movement of the support 23, thereby moving the reflection mirror 8 in the up-and-down direction.

The lamp support 25 is connected with lateral sides of the reflection mirror 8 so as to support the reflection mirror 8 via the second shaft section 24 and the third shaft section 26. For example, as illustrated in (b) of FIG. 5, the lamp support 25 is made from a plate or plates forming a shape of a substantially C-like shape so that the rotary shaft for turning around the reflection mirror 8 is attached to the lamp support 25 at two positions on the reflection mirror 8 which two positions are symmetrical with respect to the optical axis direction. The two rotary shafts are the second shaft section 24 and the third shaft section 26, respectively. The third shaft section 26 supports the reflection mirror 8 so that the reflection mirror 8 is maneuvered in the up-and-down direction in accordance with the rotation of the second shaft section 24. The shape of the lamp support 25 is not limited to this but may be arranged in any way, provided that the second shaft section 24 and the third shaft section 26 can be attached to the reflection mirror 8 so that the reflection mirror 8 is maneuvered in the up-and-down direction. In other words, the lamp support 25 may have any shape, provided that the second shaft section 24 and the third shaft section 26 are attached to the lamp support 25 so as to be perpendicular to the up-and-down direction and the optical axis direction.

Thus, the first maneuvering section 20 moves the driven section 21 in the reference direction so as to move the first shaft section 22 and the support 23. Then, the movement of the support 23 rotates the rotary shaft of the second shaft section 24, thereby moving the reflection mirror in the up-and-down direction. This allows the first maneuvering section 20 to maneuver the reflection mirror 8 in the up-and-down direction so as to move the optical axis direction of the headlamp 1 to the predetermined direction. The first maneuvering section 20 maneuvers the reflection mirror 8 in the up-and-down direction in accordance with a posture of the automobile body. This makes it possible to maintain a constant optical axis direction independently of a running state of a vehicle. This allows appropriate optical axis adjustment.

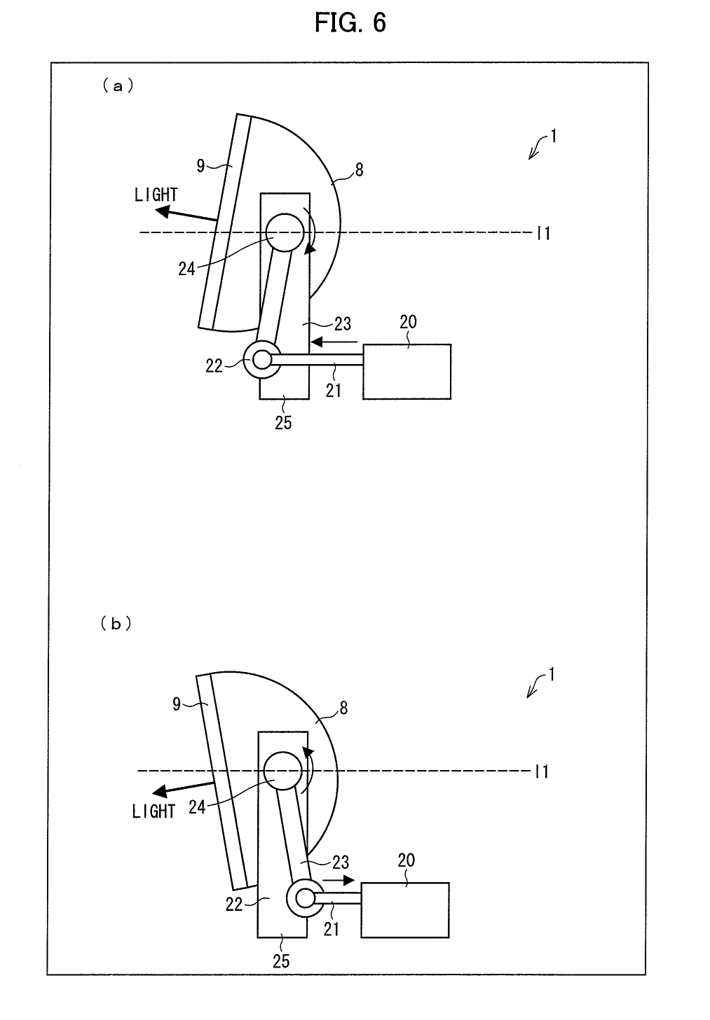

That is, in a case where optical axis adjustment is carried out so that an optical axis direction of the headlamp 1 is directed upward from the reference line 11 (i.e., the automobile body is inclined forward), the first maneuvering section 20 moves the driven section 21 in the reference direction, as illustrated in (a) of FIG. 6. The first shaft section 22 and the support 23 are moved in accordance with this movement. Accordingly, the second shaft section 24 is rotated clockwise so as to direct upward the optical axis direction of the headlamp 1. Similarly, in a case where optical axis adjustment is carried out so that an optical axis direction of the headlamp 1 is directed downward from the reference line 11 (i.e., the automobile body is inclined backward), the first maneuvering section 20 moves the driven section 21 in a direction opposite to the reference direction, as illustrated in (b) of FIG. 6. The first shaft section 22 and the support 23 are moved in accordance with this movement. Accordingly, the second shaft section 24 is rotated counterclockwise so as to direct downward the optical axis direction of the headlamp 1.

(Arrangement of First Maneuvering Section 20)

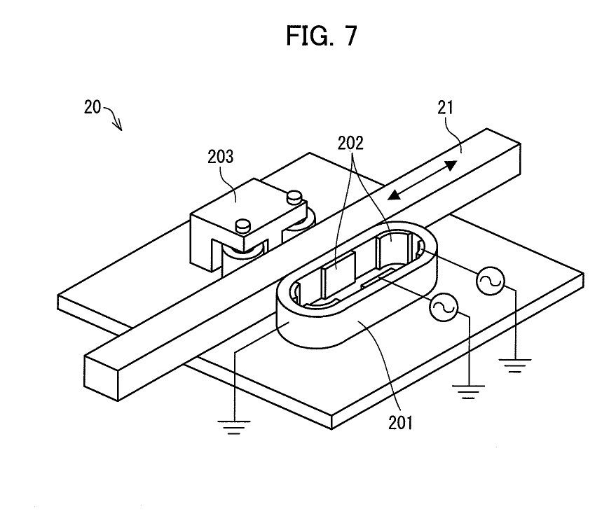

The following describes an internal arrangement of the first maneuvering section 20, with reference to FIG. 7. FIG. 7 is a view illustrating the internal arrangement of the first maneuvering section 20.

The first maneuvering section 20 includes an oval elastic member 201, a piezoelectric element 202, and a supporting roller 203. This allows the first maneuvering section 20 to serve as a linear actuator. Further, a basic structure of an ultrasonic motor is realized by the oval elastic member 201, a plurality of piezoelectric elements 202, and the driven section 21. In other words, the first maneuvering section 20 is realized by using the ultrasonic motor.

The oval elastic member 201 is a metallic member having elasticity, and has a shape of an oval loop. In the oval elastic member 201, the plurality of piezoelectric elements 202 are provided at predetermined intervals. The oval elastic member 201 is grounded.

Each of the piezoelectric elements 202 is a passive element (piezo element) utilizing a piezoelectric effect (inverse piezoelectric effect). In each of the piezoelectric elements 202, a piezoelectric material is sandwiched between two electrodes so that an electric voltage applied to the two electrodes is converted into a force. A surface of one of two electrodes of each of the piezoelectric elements 202 has contact with the oval elastic member 201 which surface does not face the piezoelectric material. Each of the piezoelectric elements 202 is connected with an AC source (not illustrated) for applying a voltage (high-frequency voltage) between the two electrodes. The electrode having contact with the oval elastic member 201 is connected with a negative electrode and the other electrode is connected with a positive electrode.

The supporting roller 203 supports the driven section by sandwiching the driven section 21 between the supporting roller 203 and the oval elastic member 201, meanwhile, the supporting roller 203 allows the driven section 21 to move when a driving force generated by the oval elastic member 201 and the piezoelectric elements 202 is transmitted to the driven section 21.

The control section 32 to be described later brings the AC source into operation. Accordingly, a voltage is applied to the piezoelectric elements 202. As a result, the piezoelectric elements 202 generate ultrasonic vibrations (approximately 10 to 100 kHz). The ultrasonic vibrations cause the oval elastic member 201 to have flexural waves. By use of the flexural waves (by use of traveling waves of the oval elastic member 201 which is caused by the flexural waves), the oval elastic member 201 drives the driven section 21. The driven section 21 is driven in a direction opposite to a traveling direction of the flexural waves.

The oval elastic member 201 and the supporting roller 203 sandwich the driven section 21 therebetween at a high pressure. This is because such arrangement is required so that a driving force brought about by the traveling waves of the oval elastic member 201 is properly transmitted to the driven section 21. If the driving force is not properly transmitted to the driven section 21, abrasion and heat generation are caused.

Thus, the first maneuvering section 20 serves as a linear actuator utilizing an ultrasonic motor. Therefore, the first maneuvering section 20 has the following characteristics.

(a) The first maneuvering section 20 makes it possible to obtain a high torque, with slow operation from several dozen to several hundred vibrations (rotations) per minute.

(b) The first maneuvering section 20 makes it possible to prevent backlash since there is no need to have a decelerator mechanism such as a gear.

(c) Even if the AC source is turned off when the headlamp 1 is directed in the predetermined direction, the first maneuvering section 20 still has a holding force enough for keeping the headlamp 1 directed in the predetermined direction.

(d) The first maneuvering section 20 exhibits an excellent responsivity because the driven section 21 has a small inertia, and a braking force brought about by friction between the oval elastic member 201 and the driven section 21 is large. The first maneuvering section 20 also can alter (control) speed in a nonstep manner. In addition, the first maneuvering section 20 exhibits such an excellent controllability that a mechanical time constant is not more than 1 (ms). The first maneuvering section 20 thus can carry out accurate speed control and accurate positional control.

(e) The first maneuvering section 20 has no coil nor magnet unlike ordinary motors. Therefore, the first maneuvering section 20 does not generate an electromagnetic wave and is not affected by magnetism. In particular, a first maneuvering section 20 constituted by a nonmagnetic motor is not made of any magnetic material. Therefore, such a first maneuvering section 20 can operate, without being affected by magnetism in a high magnetism field.

(f) The first maneuvering section 20 is smaller and lighter than an electromagnetic motor having a torque equivalent to that of the first maneuvering section 20.

(g) Since vibrations for driving have a nonaudible frequency, the first maneuvering section 20 operates with a very small operating noise. Thus, the first maneuvering section 20 has an excellent in silentness in operation.

Thus, the first maneuvering section 20 which serves as a linear actuator utilizing an ultrasonic motor makes it possible to obtain a high torque, with slow operation, achieve a high holding force in a state in which no electricity is supplied to the first maneuvering section 20 (in a non-energized state), and achieve downsizing, etc. Therefore, the first maneuvering section 20 makes it possible to desirably realize an actuator for optical axis adjustment.

(Control of Optical Axis Adjustment Mechanisms)

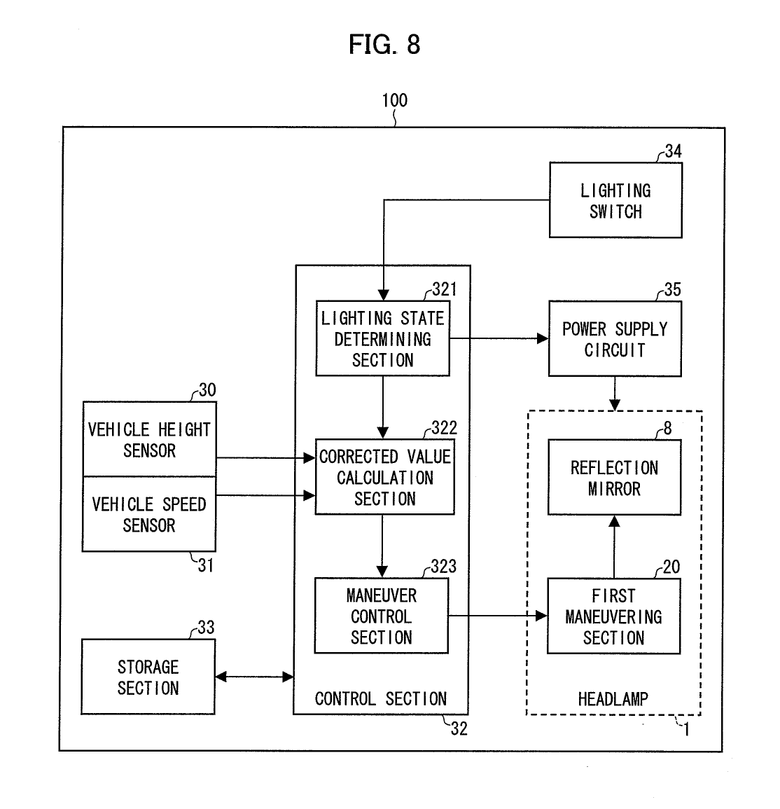

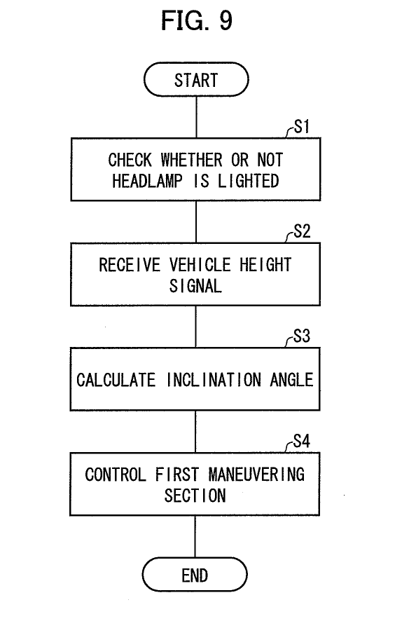

The following describes how to control the optical axis adjustment mechanisms, with reference to FIGS. 8 and 9. FIG. 8 is a block diagram illustrating a schematic arrangement of an automobile 100 having the headlamp 1. FIG. 9 is flowchart showing a flow of optical axis adjustment of the headlamp 1.

In order to carry out the optical axis adjustment of the headlamp 1, the automobile 100 includes vehicle height sensors 30, a vehicle speed sensor 31, a control section 32, a storage section 33, a lighting switch 34, and a power supply circuit 35, other than the headlamp 1. The following does not repeat describing the arrangement of the headlamp having the reflection mirror 8, the first maneuvering section 20, etc. since the arrangement is described above.

The vehicle height sensors 30 are respectively provided to (i) on a driver-side or passenger-side suspensions each provided between the automobile body and an axle in an anterior section of the automobile 100 and (ii) on a driver-side or passenger-side suspensions each provided between the automobile body and an axle in a posterior section of the automobile 100. The vehicle height sensors 30 are for measuring heights of the automobile 100 from the ground in the vicinity of tires. Each of the vehicle height sensors 30 transmits a vehicle height signal indicative of a detected vehicle height to a corrected value calculation section 322 of the control section 32. The control section 32 analyzes the vehicle height signal so as to grasp a posture (inclination) of the automobile 100.

The vehicle speed sensor 31 measures a speed of the automobile 100 on which the vehicle speed sensor 31 itself is provided. Specifically, the vehicle speed sensor 31 measures the speed of the automobile 100 on the basis of a rotation speed of an axle which rotates tires, and transmits a vehicle speed signal indicative of the detected speed to the corrected value calculation section 322 of the control section 32. For reduction in number of parts and in costs, an existing speed detecting device for detecting a vehicle speed to be displayed on a speedometer may be used as the vehicle speed sensor 31.

The control section 32 mainly includes a lighting state determining section 321, the corrected value calculation section 322, and a maneuver control section 323. The control section 32, e.g., executes a control program so as to control the components of the automobile 100. The control section 32 carries out various processes in such a manner that according to need, the control section 32 loads into a primary storage section (not illustrated) which is, e.g., a RAM (Random Access Memory), a program stored in the storage section 33 provided in the automobile 100, and executes the program.

In a case where the lighting state determining section 321 receives a switching signal (to be described later) from the lighting switch 34, the lighting state determining section 321 determines whether or not the headlamp 1 is currently in a lighted state. In a case where the lighting state determining section 321 determines that the headlamp 1 is currently in the lighted state, the lighting state determining section 321 transmits, to the power supply circuit 35, a non-supply signal to instruct the power supply circuit 35 to stop supplying electric power to the laser diodes 3, in order to put the headlamp 1 into a non-lighted state. In a case where the lighting state determining section 321 determines that the headlamp 1 is currently in the non-lighted state, the lighting state determining section 321 transmits, to the power supply circuit 35, a supply signal to instruct the power supply circuit 35 to start supplying electric power to the laser diodes 3, in order to put the headlamp 1 into the lighted state. In this case, the control section 32 determines an amount of power supply to be supplied to the laser diodes 3, and the lighting state determining section 321 adds information indicative of the amount of power supply to the supply signal so as to transmit the supply signal to the power supply circuit 35. The control section 32 may be arranged to, e.g., determine an amount of power supply on the basis of a vehicle speed signal indicative of a vehicle speed measured by the vehicle speed sensor 31.

In a case where the lighting state determining section 321 determines that the headlamp 1 is currently in the lighted state, or in a case where the lighting state determining section 321 receives a switching signal from the lighting switch 34 while the headlamp 1 is in the non-lighted state, and accordingly transmits, to the power supply circuit 35, a supply signal to put the headlamp 1 into the lighted state, the lighting state determining section 321 transmits, to the corrected value calculation section 322, a lighting state determination signal indicating that the headlamp 1 is in the lighted state.

In a case where the corrected value calculation section 322 receives the lighting state determination signal, the corrected value calculation section 322 calculates a corrected value for correcting a displacement from the reference direction, on the basis of, e.g., vehicle height signals received from the vehicle height sensors 30.

Specifically, the corrected value calculation section 322 calculates an anterior height change amount which is an amount of change of a vehicle height in the anterior section, on the basis of vehicle height signals received from two vehicle height sensors 30 in the anterior section (front wheels side). Similarly, the corrected value calculation section 322 calculates a posterior height change amount which is an amount of change of a vehicle height in the posterior section, on the basis of vehicle height signals received from two vehicle height sensors 30 in the posterior section (rear wheels side). Then, the corrected value calculation section 322 finds, by use of the following equation (1), an inclination angle (pitch angle) along a front-back direction of the automobile 100, on the basis of the anterior height change amount, the posterior height change amount, and an inter-axle distance between the front axle and the rear axle.

θp=tan⁻¹(HF−HR/Lw) (1)

where: θp is an inclination angle; HF is an anterior height change amount; HR is a posterior height change amount; and Lw is an inter-axle distance.

Then, the corrected value calculation section 322 adopts, as a corrected value, an angle which cancels out the inclination angle thus found (e.g., adopts a value obtained by multiplying the inclination angle by −1), and transmits a correction signal indicative of the corrected value to the maneuver control section 323. Although the corrected value calculation section 322 calculates a corrected value on the basis of vehicle height signals, the present embodiment is not limited to this. Alternatively, a corrected value may be calculated on the basis of a vehicle speed signal received from the vehicle speed sensor 31. In this case, a distance between the automobile 100 and a position at which the driver looks changes depending on a vehicle speed. Accordingly, the corrected value calculation section 322 may read out, from the storage section 33, a deviation (value for correcting a displacement from the predetermined direction) correlated with a vehicle speed indicated by the vehicle speed signal so as to calculate a corrected value in consideration of the deviation. The storage section 33 stores, e.g., a table in which vehicle speeds and deviations are correlated.

In a case where the maneuver control section 323 receives a correction signal from the corrected value calculation section 322, the maneuver control section 323 refers to the storage section 33 so as to determine a voltage value to be applied to the piezoelectric elements 202 of the first maneuvering section 20 which voltage value corresponds to the corrected value indicated by the correction signal, and transmits a voltage signal indicative of the voltage value to the AC source (not illustrated). The AC source applies, to the piezoelectric elements 202, a voltage corresponding to the voltage value indicated by the voltage signal. This allows the first maneuvering section 20 to maneuver the reflection mirror 8 so as to move the optical axis direction of the headlamp 1 to the predetermined direction. The storage section 33 stores, e.g., a table in which correlated are corrected values calculated by the corrected value calculation section 322 and voltage values to be applied by the AC source to the piezoelectric elements 202.

The storage section 33 stores programs to be executed by the control section 32: (1) control programs for respective sections, (2) an OS program, and (3) an application program, and (4) various kinds of data to be read out in execution of the programs. The storage section 33 is a memory device such as a HDD (Hard Disk Drive) and a semiconductor memory. According to need, a nonvolatile memory device such as a ROM (Read Only Memory) flash memory is employed as the storage section 33. The primary storage section which is described above is a volatile memory device such as a RAM. However, in some cases, the present embodiment describes the storage section 33 as also having the function of the primary storage section.

The lighting switch 34 is an operating section for switching between the lighted state and the non-lighted state of the headlamp 1. The lighting switch 34 transmits a switching signal indicative of switching to the lighted state or the non-lighted state, to the lighting state determining section 321 of the control section 32.

The power supply circuit 35 is a circuit for controlling power supply in accordance with a supply signal or a non-supply signal transmitted from the lighting state determining section 321 of the control section 32. In a case where the power supply circuit 35 receives a supply signal, the power supply circuit 35 receives power supply (direct current) from a battery (not illustrated) which is commonly provided to an automobile, and supplies a direct current to the laser diodes 3 in accordance with a supply amount indicated by the supply signal. In a case where the power supply circuit 35 receives a non-supply signal, the power supply circuit 35 stops supplying a direct current to the laser diodes 3.

The following describes a flow of optical axis adjustment of the headlamp 1, with reference to FIG. 9.

First, the lighting state determining section 321 checks whether or not the headlamp 1 is currently in the lighted state (Step S1; hereinafter, “step” is simply referred to as “S”). In a case where the lighting state determining section 321 determines that the headlamp 1 is in the lighted state (or in a case where the lighting state determining section 321 receives a switching signal from the lighting switch 34, and transmits a supply signal to the power supply circuit 35 so as to put the headlamp 1 into the lighted state), the lighting state determining section 321 transmits a lighting state determination signal to the corrected value calculation section 322.

In a case where the corrected value calculation section 322 receives the lighting state determination signal, the corrected value calculation section 322 receives vehicle height signals from the vehicle height sensors 30 (S2). The corrected value calculation section 322 finds an anterior height change amount and a posterior height change amount on the basis of the vehicle height signals so as to find an inclination angle by use of the equation (1). Then, the corrected value calculation section 322 finds a corrected value by multiplying the inclination angle by −1, and transmits a correction signal indicative of the corrected value to the maneuver control section 323 (S3).

In a case where the maneuver control section 323 receives the correction signal, the maneuver control section 323 determines a voltage value corresponding to the correction value, and transmits the voltage value to the AC source (not illustrated), thereby controlling the first maneuvering section 20 (S4).

Thus, the present embodiment realizes a high-luminance headlamp 1 by providing thereto the laser diodes which emit laser beams and the light-emitting section 7 which emits light in response to the laser beams emitted from the laser diodes 3. Accordingly, in a case where the headlamp 1 emits light having a luminous flux comparable to that of a conventional headlamp (i.e., in a case where the headlamp 1 emits light having a luminous flux within a legally-stipulated range), the light-emitting section 7 can be designed to be smaller than a light-emitting section (light source) of the conventional headlamp. As a result, the headlamp 1 can be designed to be small and light. That is, the reflection mirror 8 can also be designed to be small and light. Particularly, it is possible to realize a headlamp 1 which is drastically smaller and lighter than an LED headlamp utilizing a plurality of LED modules which LED headlamp is large and heavy as a whole.

Further, the headlamp 1 includes the first maneuvering section 20 which maneuvers at least the reflection mirror 8 so as to move an optical axis direction of a bundle of rays formed by the reflection mirror 8 to the predetermined direction. In a case where the first maneuvering section 20 carries out optical axis adjustment so as to move the optical axis direction to the predetermined direction, the first maneuvering section 20 maneuvers the reflection mirror 8 of the headlamp 1 which is designed to be smaller and lighter than a conventional headlamp. This makes it possible to improve the responsivity of the reflection mirror 8 (including at least the light-emitting section 7) to optical axis adjustment, as compared to conventional headlamps. In addition, this makes it possible to prevent a person in an oncoming vehicle from being dazzled by the headlamp 1 having a high luminance and high luminous flux (i.e., by a headlight (headlamp) system with a high light intensity) because the first maneuvering section 20 maintains the optical axis direction in the predetermined direction. This makes it possible to secure traffic safety.

In other words, by employing, as a light-emitting device of the headlamp 1, the illumination device with a high luminance and a high luminous flux which illumination device is realized by the laser diodes 3 and the light-emitting section 7, it is possible to obtain, with one lamp, a legally-required luminous flux, and reduce a size of the one lamp, unlike halogen lamps and HID lamps which are conventional light sources, and LED light sources each of which requires multiple lamps. Accordingly, the headlamp 1 makes it possible to reduce a size of a maneuvering object (at least the reflection mirror 8) to be maneuvered in optical axis adjustment, and therefore reduce a weight of the maneuvering object. This makes it possible to drastically improve responsive followability of the maneuvering object in optical axis adjustment. In other words, this allows the maneuvering object to follow the optical axis adjustment in quick response to a postural change of a vehicle.

Further, because it is possible to reduce a size and a weight of the headlamp 1, it is possible to downsize and simplify the optical axis adjustment mechanisms to be provided in the headlamp 1. This makes it possible to reduce failures due to the movement of the reflection mirror 8 by the first maneuvering section 20. This makes it possible to realize a long-life headlamp 1.

Further, the first maneuvering section 20 maneuvers at least the reflection mirror 8 in the up-and-down direction. This makes it possible to surely carry out legally-stipulated optical axis up-and-down adjustment, even if the headlamp 1 emits light having a luminous flux of more than 2000 lm. This makes it possible to secure traffic safety. For example, it is possible to prevent a driver in an oncoming vehicle (or other transportation means) from being dazzled when passing each other.

Further, the first maneuvering section 20 is realized by using the ultrasonic motor having the oval elastic member 201, the piezoelectric elements 202 and the driven section 21. This allows the first maneuvering section 20 to have such characteristics of an ultrasonic motor that: it is possible to obtain a high torque, with slow operation; it is possible to realize a high holding force in a state in which no electricity is supplied to the first maneuvering section 20 (in a non-energized state); it is possible to downsize the first maneuvering section 20; etc. This allows the first maneuvering section 20 to function as an actuator for optical axis adjustment sufficiently.

Further, the headlamp 1 includes the optical fiber 5 which receives laser beams emitted from the laser diodes 3 and emits the laser beams toward the light-emitting section 7. This makes it possible to spatially separate the laser diodes 3 and the light-emitting section 7. Furthermore, it is possible to provide the laser diodes 3 outside the reflection mirror 8. Particularly, the optical fiber 5 has a high optical connection efficiency. This makes it possible to provide the laser diodes 3 and the light-emitting section 7 at a sufficient distance.

By providing the laser diodes outside the reflection mirror 8, the first maneuvering section 20 does not have to maneuver at least the reflection mirror 8 together with the laser diodes 3 in optical axis adjustment. This makes it possible to further downsize the maneuvering object to be maneuvered, and therefore reduce a weight thereof. In optical axis adjustment of a conventional light source, it is necessary to maneuver a whole headlamp (lamp) integrated with a light source. Accordingly, the maneuvering object has a difficulty in quickly following the optical axis adjustment. In contrast, the headlamp 1 allows the maneuvering object to quickly follow the optical axis adjustment since the headlamp 1 is smaller and lighter than conventional headlamps, the laser diodes 3 are provided outside the reflection mirror 8.

Conventional light sources (e.g., HID lamps) cannot be arranged such that the laser diodes 3 are not maneuvered in optical axis adjustment. This is because a light source of a conventional headlamp has a function of a light-emitting section, and it is accordingly necessary to maneuver the light source itself in optical axis adjustment.

Further, the optical fiber 5 has flexibility. Therefore, even if the first maneuvering section 20 maneuvers the reflection mirror 8, the laser diodes 3 provided outside the reflection mirror 8 are not maneuvered in response to the movement of the reflection mirror 8. In other words, employment of the optical fiber 5 makes it possible to realize such an arrangement that the laser diodes 3 are not maneuvered in response to the movement of the reflection mirror 8 in optical axis adjustment.

Further, the flexibility of the optical fiber 5 makes it possible to easily alter a relative positional relationship between the laser diodes 3 and the light-emitting section 7. By adjusting a length of the optical fiber 5, it is possible to provide the laser diodes 3 at a position away from the light-emitting section 7. This increases a freedom of design of the headlamp 1. For example, it is possible to provide the laser diodes 3 in a position where the laser diodes 3 can be easily cooled or replaced. In other words, employment of the optical fiber 5 makes it possible to realize such an arrangement that the laser diodes 3 are provided outside the reflection mirror

### Second Embodiment

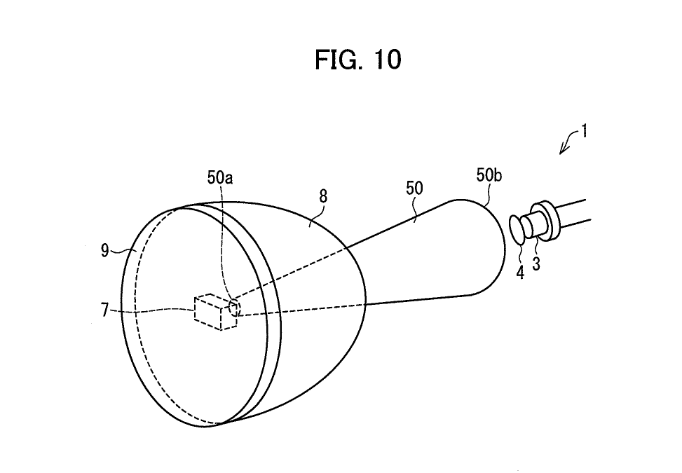

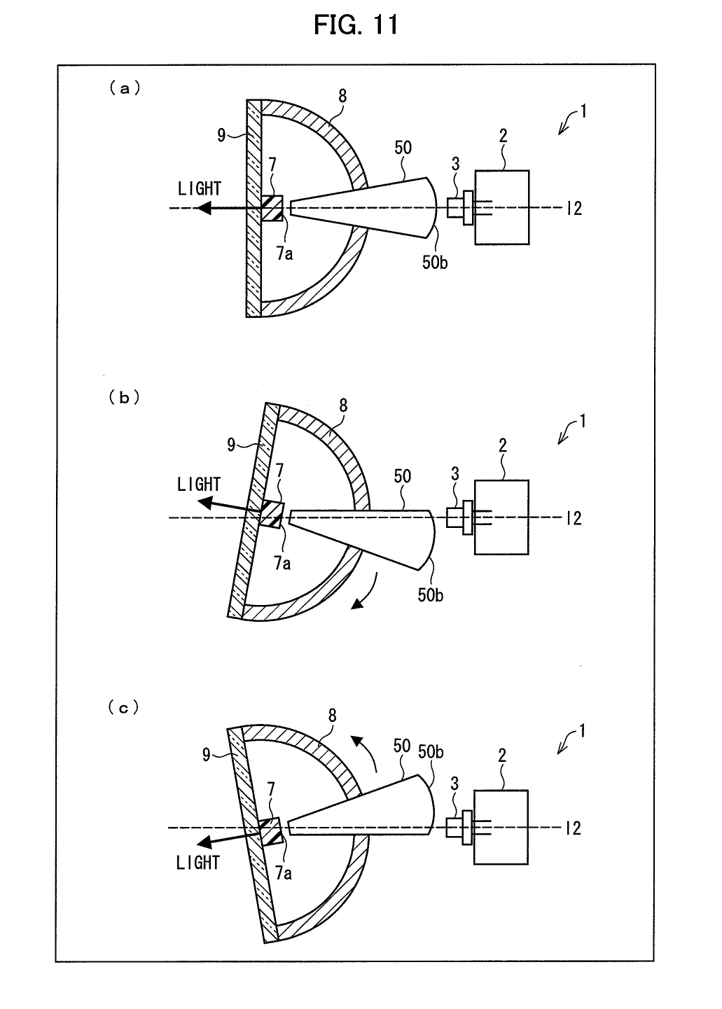

The following describes another embodiment of the present invention, with reference to FIGS. 10 and 11. Members which are the same as those of the first embodiment are given common reference signs, and the following omits descriptions of such members. The present embodiment uses a sectorial light guide section (light guide section) 50 instead of the optical fiber 5. FIG. 10 is a perspective view illustrating a schematic arrangement of a headlamp 1 having the sectorial light guide section 50. Although FIG. 10 omits to illustrate: optical axis adjustment mechanisms such as the first maneuvering section 20; the housing 10; the extension 11; the lens 12; etc., the headlamp 1 of the present embodiment is arranged in the same manner as the first embodiment.

As illustrated in FIG. 10, the headlamp 1 includes a laser diode 3, an aspheric lens 4, the sectorial light guide section (light guide section) 50, a light-emitting section 7, a reflection mirror 8, and a transparent plate 9. A basic structure of a light-emitting device is made up of the laser diode 3, the sectorial light guide section 50, and the light-emitting section 7.

The laser diode 3 is arranged such that: light-emitting points are provided on a single chip has 10 (10 stripes); the laser diode 3 emits a laser beam having a wavelength of, e.g., 405 nm (blue-violet light); an output is 11.2 W; an operation voltage is 5 V; and an operating current is 6.4 A. The laser diode 3 is contained in a package having a diameter of 9 mm. A single laser diode 3 is sealed in the package. A power consumption for the output above is 32 W. The laser diode 3 is provided outside the reflection mirror 8 so as to face the laser beam-irradiated surface 7a of the light-emitting section 7.

The aspheric lens 4 functions to cause a laser beams emitted from the laser diode 3 to enter an end of the sectorial light guide section 50, that is, a light incident surface (incident surface) 50b. The present embodiment employs a rod lens as the aspheric lens 4.

The sectorial light guide section 50 is a light guide member which concentrates the laser beam emitted from the laser diode 3 and guides the laser beam to the light-emitting section 7 (laser beam-irradiated surface 7a). The sectorial light guide section 50 is optically connected with the laser diode 3 via the aspheric lens 4. The sectorial light guide section 50 has a light incident surface 50b for receiving the laser beam emitted from the laser diode 3, and a light emitting surface 50a for emitting, toward the light-emitting section 7, the laser light received by the light incident surface 50b. The sectorial light guide section 50 may have a shape of, e.g., a truncated cone or a truncated pyramid. A plurality of sectorial light guide sections 50 may be provided for a plurality of laser diodes 3, respectively.

The sectorial light guide section 50 is a light guide member (refractive index: 1.45) made from quartz (SiO₂). The light emitting surface 50a (top surface of the sectorial light guide section 50) has a diameter of 2 mm. A side surface of the sectorial light guide section 50 is coated with a thermoplastic fluororesin (polytetrafluoroethylene: PTFE) having a refractive index of 1.35. The light emitting surface 50a may be a flat surface or a curved surface.

Further, the sectorial light guide section 50 is corrected so as to make an aspect ratio of FFP (Far Field Pattern) as close to a perfect circle as possible. As used herein, the FFP indicates distribution of luminous intensities in a surface at a distance from a luminous point of a laser source. Generally, a laser beam emitted from an active layer of a semiconductor light emitting element such as the laser diode 3 or of a side surface light emitting-type diode will be dispersed widely due to a diffraction phenomenon, so that the FFP becomes an elliptical shape. Therefore, correction is needed for making the FFP close to a perfect circle.

The sectorial light guide section 50 is fixed to the reflection mirror 8 at a position on a straight line connecting the laser diode 3 and the light-emitting section 7 so that the sectorial light guide section 50 is maneuvered together with the reflection mirror 8. That is, in a case where a normal to the surface of the transparent plate 9 faces right front during the halting of the vehicle, arranged on the optical axis (reference line 12 in FIG. 11) are the laser diode 3, the light-emitting section 7, and the sectorial light guide section 50. The light incident surface 50b of the sectorial light guide section 50 has such a cross-sectional shape (sectorial shape) that an up-and-down cross-section of the light incident surface 50b is an arc centering the laser beam-irradiated surface 7a. In other words, the light incident surface 50b has a cross-sectional shape which makes it possible to locate, even if the optical axis direction is displaced from the reference line 12 in FIG. 11, the laser diode 3 in any one of positions which are at an equal distance from the center of the laser beam-irradiated surface 7a so that the first maneuvering section 20 maneuvers the reflection mirror 8 so as to move the optical axis direction of the headlamp 1 to the predetermined direction.

According to the present embodiment, the headlamp 1 is designed such that the reflection mirror 8 is maneuvered, centering around the light-emitting section 7 in the up-and-down direction. Accordingly, the lamp support 25 is provided so that the second shaft section 24 and the third shaft section 26 are located right beside the light-emitting section 7. an up-and-down length of the light incident surface 50b is arranged to allow at least a range of the up-and-down movement of the reflection mirror 8.

The following describes how the first maneuvering section 20 maneuvers the reflection mirror 8, with reference to FIG. 11. FIG. 11 is a view illustrating how the first maneuvering section 20 maneuvers the reflection mirror 8.

(a) of FIG. 11 illustrates the headlamp 1 facing right front. In this case, the optical axis direction of the headlamp 1 matches the direction along the reference line 12 (matches the reference direction). Accordingly, the light is emitted right frontward.

(b) of FIG. 11 illustrates the headlamp 1 maneuvered to face upward from the reference line 12. (c) of FIG. 11 illustrates the headlamp 1 maneuvered to face downward from the reference line 12. In these cases, the optical axis direction of the headlamp 1 is displaced from the reference direction. However, the laser beam-irradiated surface 7a is surely irradiated with the laser beam emitted from the laser diode 3 via the sectorial light guide section 50. The light-emitting section 7 converts the laser light into fluorescence. The fluorescence is emitted in a direction of the normal to the transparent plate 9 (in the predetermined direction obtained by optical axis adjustment). In other words, even in a case where optical axis adjustment is carried out in accordance with a running state of a vehicle, it is possible to surely irradiate the light-emitting section 7 with the laser beam emitted from the laser diode 3.

The aspheric lens 4 and the sectorial light guide section 50 have an optical connection efficiency (i.e., a light intensity of the laser beam to be emitted from the light emitting surface 50a of the sectorial light guide section 50 in a case where an intensity of the laser beam emitted from the laser diode 3 is 1) of 90%. Accordingly, the laser beam of 11.2 W which is emitted from the laser diode 3 passes through the aspheric lens 4 and the sectorial light guide section 50 so as to be emitted from light emitting surface 50a as a laser beam of approximately 10 W.

Thus, the headlamp 1 of the present embodiment is arranged such that the laser beam emitted from the laser diode 3 is emitted via the light emitting surface 50a of the sectorial light guide section 50 so that the laser beam-irradiated surface 7a of the light-emitting section 7 is irradiated with the laser beam. Accordingly, the present embodiment makes it possible to realize a headlamp 1 which achieves a high luminance and a high luminous flux. Specifically, light emitted from the light-emitting section 7 has a luminous flux of approximately 1600 lm, and a luminance of the light-emitting section 7 is 80 cd/mm². Further, the present embodiment makes it possible to realize a small lightweight headlamp 1.

Further, the sectorial light guide section 50 is fixed to the reflection mirror 8 so as to be maneuvered together with the reflection mirror 8. In addition, the light incident surface 50b of the sectorial light guide section 50 has a cross-sectional shape which makes it possible to locate the laser diode 3 in any one of positions which are at an equal distance from the center of the laser beam-irradiated surface 7a. Therefore, a distance between the light incident surface 50b and the laser beam-irradiated surface 7a (i.e., length of an optical path on which the laser beam travels) does not vary whichever direction the first maneuvering section 20 maneuvers the reflection mirror 8. This makes it possible to maintain substantially the constant distance between the laser diode 3 and the reflection mirror 8. In other words, independently of the direction of the reflection mirror 8, it is possible to keep a distance between the laser diode 3 and the reflection mirror 8 equal to a distance therebetween obtained in a case where the reflection mirror 8 is directed right frontward during the halting of a vehicle.

Thus, even if the sectorial light guide section 50 is adopted instead of the optical fiber 5, it is still possible to maintain the optical axis direction in the predetermined direction. This makes it possible to carry out appropriate optical axis adjustment.

### Third Embodiment

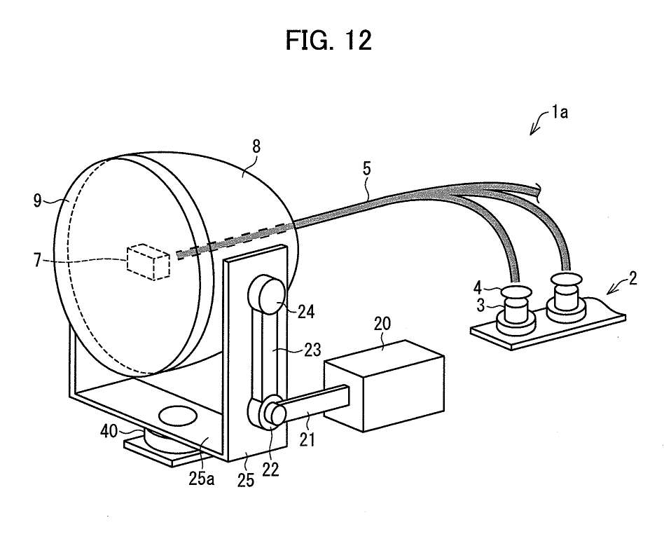

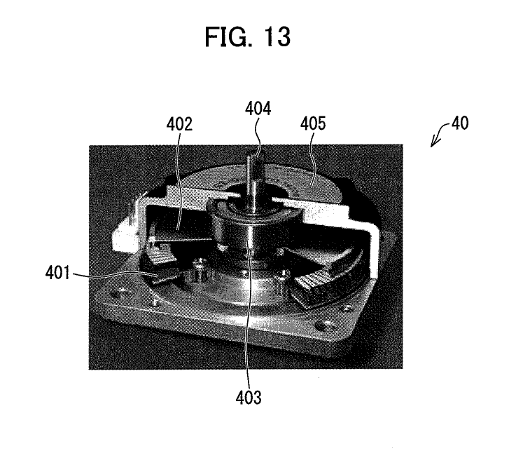

The following describes another embodiment of the present invention, with reference to FIGS. 12 and 13. Members which are the same as those of the first embodiment and the second embodiment are given common reference signs, and the following omits descriptions of such members. The present embodiment deals with a schematic arrangement of a headlamp 1a which is a modification of the headlamp 1. FIG. 12 is a view illustrating the schematic arrangement of the headlamp 1a, specifically, a perspective view illustrating a schematic arrangement encompassing the optical axis adjustment mechanisms for adjusting an optical axis of light emitted from the headlamp 1a.

As illustrated in FIG. 12, the lamp support 25 having a C-like shape has a bottom plate 25a under the reflection mirror 8 (i.e., on a ground side), and a second maneuvering section 40 is provided directly on the bottom plate 25a, in substantially the center of the bottom plate 25a. As shown in FIG. 13, the second maneuvering section 40 is a rotary ultrasonic motor, and its motor shaft section 404 is attached to the bottom plate 25a. The motor shaft section 404 is attached so as to be perpendicular to the second shaft section 24 (so as to be in the up-and-down direction). Accordingly, the second maneuvering section 40 maneuvers at least the reflection mirror 8 in the horizontal direction (lateral direction) so as to move the optical axis direction of the light reflected by the reflection mirror 8 to the predetermined direction.

The following describes an internal arrangement of the second maneuvering section 40, with reference to FIG. 13. The second maneuvering section 40 includes a stator 401, a rotor 402, a bearing 403, the motor shaft section 404, and a casing 405. Thus, an ultrasonic motor is realized.

The stator 401 is made up of a circular elastic member and a piezoceramic which have the same functions as those of the oval elastic member 201 and the piezoelectric elements 202 of the first maneuvering section 20 illustrated in FIG. 7. That is, in a case where a voltage is applied to the piezoceramic, the piezoceramic has ultrasonic vibrations. Due to the ultrasonic vibrations, a metallic elastic member has flexural waves. By use of the flexural waves, the stator 401 drives the rotor 402. The piezoceramic is connected with an AC source (not illustrated) for the second maneuvering section 40.

The rotor 402 is a circular metallic plate which is provided above the stator 401. The rotor 402 is subjected to a driving force whose direction is opposite to that of traveling waves that the circular elastic member of the stator 401 has due to the flexural waves. The rotor 402 is pressed against the stator 401 with a high pressure so that a driving force from the stator 401 is properly transmitted to the rotor 402 (so that heat generation from the stator 401 and the rotor 402 and abrasion thereof are prevented).

The bearing 403 is located in a central area of the rotor 402, and supports the motor shaft section 404. The bearing 403 transmits, to the motor shaft section 404, a driving force transmitted to the rotor 402.

The motor shaft section 404 is located in a central area of the bearing 403, and sticks out from the center of the casing 405. The motor shaft section 404 is a rotary shaft which is rotated by a driving force transmitted from the bearing 403 (i.e., a driving force transmitted from the stator 401 to the rotor 402).

Then, the following describes how the optical axis adjustment mechanisms of the headlamp 1a is controlled. The corrected value calculation section 322 and the maneuver control section 323 which are illustrated in FIG. 8 carries out not only calculation of a corrected value for the first maneuvering section 20 and control of the first maneuvering section 20, but also calculation of a corrected value for the second maneuvering section 40 and control of the second maneuvering section 40.

The corrected value calculation section 322 (i) calculates an anterior height change amount on the basis of vehicle height signals from the vehicle height sensors 30, (ii) finds a lateral inclination angle of the automobile 100 along its lateral direction (direction perpendicular to the axle and the up-and-down direction), (iii) adopts, as a lateral corrected value, an angle which cancels out the lateral inclination angle (e.g., a value found by dividing the lateral inclination angle by −1), and transmits a lateral correction signal indicative of the lateral corrected value to the maneuver control section 323.

In a case where the maneuver control section 323 receives the lateral correction signal, the maneuver control section 323 refers to the storage section 33 so as to determine a voltage value to be applied to the piezoceramic of the second maneuvering section 40 which voltage value corresponds to the lateral corrected value indicated by the lateral correction signal, and transmits a voltage signal indicative of the voltage value to the AC source (not illustrated) for the second maneuvering section 40. The AC source applies, to the piezoceramic, a voltage corresponding to the voltage value indicated by the voltage signal. This allows the second maneuvering section 40 to maneuver the reflection mirror 8 so as to move the optical axis direction of the headlamp 1a to the predetermined direction.

The headlamp 1a thus includes the second maneuvering section 40. This makes it possible to maneuver the reflection mirror 8 not only in the up-and-down direction but also in the lateral direction. This makes it possible to carry out optical axis adjustment in accordance with a horizontal inclination of a vehicle. This makes it possible to carry out optical axis adjustment so that the legal stipulation is met and the headlamp 1a irradiates a position that a driver sees in a case where, e.g., a vehicle goes downhill along a curved road.

Further, the second maneuvering section 40 is realized by using the ultrasonic motor having the stator 401 and the rotor 402. This allows the second maneuvering section 40 to have such characteristics of an ultrasonic motor that: it is possible to obtain a high torque, with slow operation; it is possible to realize a high holding force in a non-energized state; it is possible to downsize the second maneuvering section 40; etc. This allows the second maneuvering section to fulfill a function of an actuator for optical axis adjustment.

### Fourth Embodiment

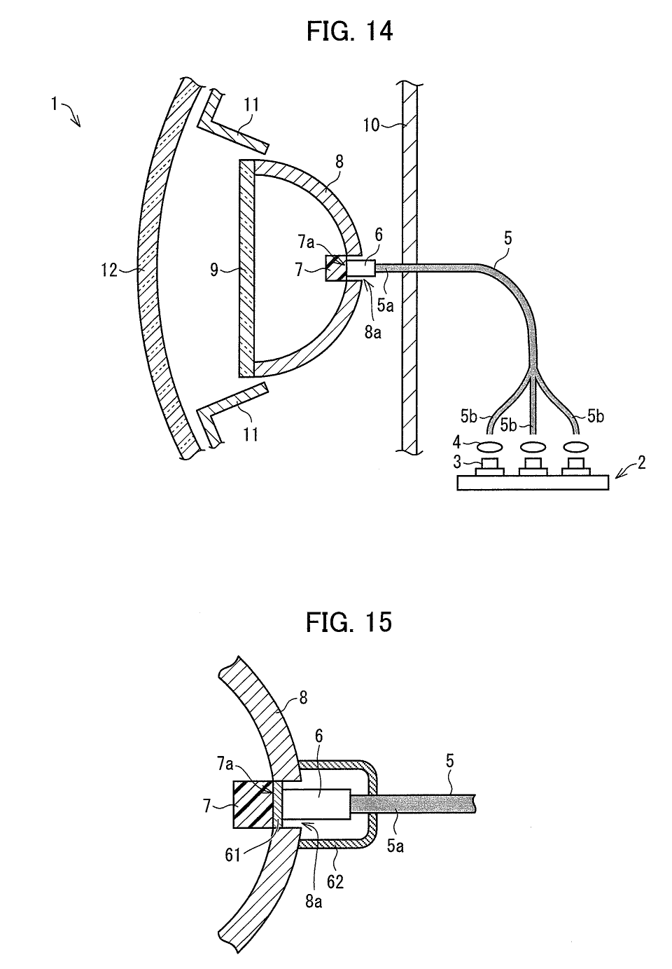

The following describes another embodiment of the present invention, with reference to FIGS. 14 through 16. Members which are the same as those of the first through third embodiments are given common reference signs, and the following omits descriptions of such members. The present embodiment deals with such an arrangement that a light-emitting section 7 is held not by a transparent plate 9 but by a reflection mirror 8. FIG. 14 is a cross-sectional view illustrating a schematic arrangement of a headlamp 1 of the present embodiment. FIG. 15 is a view illustrating a positional relationship between the light-emitting section 7 and emission end sections 5a of optical fiber 5.

As described above with reference to FIGS. 2 and 3, the emission end sections 5a may have contact with the laser beam-irradiated surface 7a, or may be positioned at a small distance from the laser beam-irradiated surface 7a. In case where the emission end sections 5a are positioned at a small distance from the laser beam-irradiated surface 7a, there is a risk that the laser beam-irradiated surface 7a cannot be appropriately irradiated with the laser beams emitted from the emission end sections 5a due to an impact on the headlamp 1. In this case, the laser beams are reflected outside from the reflection mirror 8 without being converted into incoherent light by the light-emitting section 7. In a case where, e.g., the light-emitting section 7 is provided on the transparent plate 9 as illustrated in FIG. 2, the laser beams propagate through a space enclosed by the reflection mirror 8 and the transparent plate 9 (i.e., a space formed by the reflection mirror 8 and the opening thereof) so that the laser beams are reflected outside from the reflection mirror 8.

That is, in a case where the emission end sections 5a are positioned at a small distance from the laser beam-irradiated surface 7a (particularly in the case of the arrangement of FIG. 2), there is a risk that coherent laser beams having an output level which is harmful to humans are emitted to the outside of the headlamp 1 (toward the front of the headlamp 1). In particular, it is necessary to prevent the emission of the laser beams to the outside of the headlamp 1, particularly, toward the front thereof, for the reason that the laser beams emitted from the laser diodes 3 are high-power laser beams.

In view of this, the emission end sections 5a and the laser beam-irradiated surface 7a preferably have contact with each other (or are in close proximity to each other), or optical paths of the laser beams are preferably covered. That is, in a case where the emission end sections 5a and the laser beam-irradiated surface 7a are positioned with a gap therebetween, it is preferable to spatially cut off (i) the optical paths of the laser beams therebetween and (ii) a space outside the optical paths from each other (e.g., a space enclosed by the reflection mirror 8 and the transparent plate 9).

In FIG. 14, the reflection mirror 8 has, in its bottom part, a hollow section 8a into which the emission end sections 5a are inserted. The light-emitting section 7 is provided so that a center of the laser beam-irradiated surface 7a is located at a center of the hollow section 8a. Further, a ferrule 6 for holding the emission end sections 5a is inserted into the hollow section 8a. That is, in FIG. 14, the laser beam-irradiated surface 7a and the emission end sections 5a are in close proximity to each other in the hollow section 8a of the reflection mirror 8.

This makes it possible to surely irradiate the laser beam-irradiated surface 7a with the laser beams emitted from the emission end sections 5a. This makes it possible to prevent such a problem that in a case where, e.g., the headlamp 1 is subjected to an impact of some sort, the laser beam-irradiated surface 7a is not irradiated with laser beams having an output level which is harmful to humans (i.e., the laser beams are not converted into incoherent light) so that the laser beams directly leak out to the outside of the headlamp 1. This makes it possible to realize a headlamp 1 with a high level of safety.

There is no need to dispose the laser beam-irradiated surface 7a and the emission end sections 5a in close proximity to each other, in order to prevent the propagation of the laser beams through the space (region) enclosed by the reflection mirror 8 and the transparent plate 9. In other words, the light-emitting section 7 is provided so that the light beam-irradiated surface 7a is located outside of a space formed by the reflection mirror 8 and the opening thereof. Note that the “outside of a space” is a notion which encompasses the boundary of the space and the outside of the space.

For example, FIGS. 14 and 15 show that the light-emitting section 7 is provided so that the laser beam-irradiated surface 7a is located at least on a same plane as the reflection surface of the reflection mirror 8 for reflecting the light emitted from the light-emitting section 7 (to be outside of the reflection mirror 8, i.e., to be outside of the space). Further, the light-emitting section 7 itself may be provided outside the reflection mirror 8 inside the headlamp 1. In this case, the light-emitting section 7 is provided, e.g., inside a tube (a material for the tube is one which blocks a laser beam) in which the hollow section 8a is extended. Further, it may be arranged such that a part of the light-emitting section 7 is located inside the space, and the laser beam-irradiated surface 7a is located outside the space (inside the hollow section 8a). In this case, a shape and a size of the laser beam-irradiated surface 7a are the same as those of the aperture plane of the hollow section 8a.

In the case of the arrangement, the light-emitting section 7 does not receive the high-power laser beams in the space. That is, the arrangement makes it possible to prevent the laser beams having an output level which is harmful to humans from propagating through the space so as to leak out in the light irradiation direction of the headlamp 1. Further, the arrangement makes it possible to prevent the laser beams from directly leaking out at least in the light irradiation direction even if the laser beam-irradiated surface 7a is not irradiated with the laser beams in a case where, e.g., the headlamp 1 is subjected to an impact of some sort.

FIG. 14 shows that the reflection mirror 8 has the hollow section 8a in its bottom part. However, the present embodiment is not limited to this. That is, the hollow section 8a may be provided in any part of the reflection mirror 8.

Further, the light-emitting section 7 is disposed so as to completely cover the hollow section 8a. Because of this, the laser beams emitted from the emission end sections 5a is prevented from entering the region enclosed by the reflection mirror 8 and the transparent plate 9 so as to be emitted via the opening of the reflection mirror 8. For this purpose, the hollow section 8a has a size which is not greater than a size of the laser beam-irradiated surface 7a (in a case where the laser beam-irradiated surface 7a has a rectangular shape having a size of 3 mm×1 mm, the hollow section 8a has an aperture plane of not greater than 3 mm²). The hollow section 8a does not necessarily have to have a shape identical with the shape of the laser beam-irradiated surface 7a, provided that the light-emitting section 7 can completely cover the hollow section 8a.

In order to surely prevent the laser beams from propagating through the space enclosed by the reflection mirror 8 and the transparent plate 9, it is preferably that (1) the light-emitting section 7 be held not by the transparent plate 9 but by the reflection mirror 8; (2) the laser beam-irradiated surface 7a and the emission end sections 5a be disposed in close proximity to each other; and (3) the light-emitting section 7 be disposed so as to completely cover the hollow section 8a.

As illustrated in FIG. 15, the light-emitting section 7 and the ferrule 6 are provided with a heat-releasing member 61 disposed to intervene the light-emitting section 7 and the ferrule 6. That is, the laser beam-irradiated surface 7a and the emission end sections 5a are in close proximity to each other via the heat-releasing member 61.

The heat-releasing member 61 releases heat which is generated by irradiating the light-emitting section 7 with the laser beams. The heat-releasing member 61 is provided so as to have contact with the laser beam-irradiated surface 7a. The heat-releasing member 61 is made from a material which is transparent and has a high thermal conductivity, such as gallium nitride, magnesia (MgO), or sapphire.

The heat-releasing member 61 is a plate-like member, and is provided inside the hollow section 8a so as to cover the aperture plane of the hollow section 8a. The light-emitting section 7 and the emission end sections 5a are disposed so that the laser beam-irradiated surface 7a is thermally connected with one surface (laser beam-emitting surface) of the heat-releasing member 61, and the emission end sections 5a have contact with or are in close proximity to the other surface (laser beam-receiving surface) of the heat-releasing member 61.

A shape of the heat-releasing member 61 is not limited to one which covers the aperture plane of the hollow section 8a, provided that the heat generated from the light-emitting section 7 can be released, e.g., into the reflection mirror 8. That is, the heat-releasing member 61 may be a linear member encompassing a bar-like one and a tube-like one which linear member is extended from the reflection mirror 8 and has contact with a part of the laser beam-irradiated surface 7a.

In a case where, e.g., the heat-releasing member 61 is such a linear member and is provided only in a position away from a center of the optical axis (i.e., in a peripheral part of the laser beam-irradiated surface 7a), the heat-releasing member 61 does not necessarily have to be transparent. However, the heat-releasing member 61 is preferably transparent, from a viewpoint of utilization efficiency of the laser beams. In a case where the heat-preferably transparent, from a viewpoint of utilization efficiency of the laser beams. In a case where the heat-releasing member 61 has a tube-like shape and is provided only in the peripheral part of the laser beam-irradiated surface 7a, it is also possible to further improve the heat release by passing or circulating a liquid, a gas, or the like through the tube.

There is such a problem that a minute light-emitting section containing a fluorescent substance will be, in general, deteriorated severely by being exited with high-power excitation light (i.e., by exciting the light-emitting section at a high power density).

One of causes of the deterioration is temperature rises in that irradiated region of the light-emitting section which is irradiated with the excitation light and in a region in the vicinity of the irradiated region (the region is referred to as temperature-increase region). In this case, by irradiating the light-emitting section with high-power excitation light (laser beam) emitted from a laser diode, only the temperature-increase region is locally heated to an extremely high temperature. This results in a problem of rapid deterioration of the temperature-increase region.

Accordingly, there is a demand for suppression of the temperature rise in the temperature-increase region in order that the deterioration of the light-emitting section is temperature rise in the temperature-increase region in order that the deterioration of the light-emitting section is prevented so that a bright long-life light source is realized in such an arrangement that the minute light-emitting section containing a fluorescent substance is excited with the high-power excitation light.

Particularly in a case where the laser beam-irradiated surface 7a and the emission end sections 5a are in close proximity to each other as illustrated in FIGS. 14 and 15, there is little distance therebetween. It follows that the irradiated region is irradiated with more intense laser beams. This leads to a risk that such irradiation causes an extremely large amount of heat generation in the temperature-increase region, and a temperature rise thus caused in the temperature-increase region rapidly deteriorates the light-emitting section 7.

The headlamp 1 illustrated in FIG. 15 is arranged such that the heat-releasing member 61 is provided in the hollow section 8a, and the emission end sections 5a and the light-emitting section 7 are in close proximity to each other via the heat-releasing member 61. This makes it possible to release, into the reflection mirror 8 via the heat-releasing member 61, the heat which is generated from the light-emitting section 7 by irradiating the laser beam-irradiated surface 7a with the laser beams. This makes it possible to attain a longer life of the light-emitting section 7. If there is no need to consider this, the heat-releasing member 61 is not necessarily required.

Further, as illustrated in FIG. 15, the headlamp 1 includes, in the vicinity of the laser beam-irradiated surface 7a and the emission end sections 5a, a light-blocking section 62 for blocking at least one of (i) the laser beams emitted from the emission end sections 5a but not irradiating the laser beam-irradiated surface 7a and (ii) the laser beams emitted from the emission end sections 5a and then reflected from the laser beam-irradiated surface 7a. By connecting the light-blocking section 62 with the reflection mirror 8, the light-blocking section 62 and the reflection mirror 8 form an enclosed space which encloses at least the vicinity of the laser beam-irradiated surface 7a and the emission end sections 5a. FIG. 15 shows the enclosed space which encloses the ferrule 6, the laser beam-irradiated surface 7a, and the heat-releasing member 61. A material for the light-blocking section 62 may be any material, provided that the material blocks a wavelength of the laser beams and a wavelength close thereto.

It is possible to prevent the emission of the laser beams toward the front of the headlamp 1 in such a manner that, e.g., the aperture plane of the hollow section 8a is covered with the light-emitting section 7 so that the laser beams do not leak out into the space enclosed by the reflection mirror 8 and the transparent plate 9. However, according to the arrangement, in a case where the laser beam-irradiated surface 7a is not appropriately irradiated with the laser beams due to, e.g., an impact on the headlamp 1, there is a possibility that the laser beams leak out from the hollow section 8a (from a connecting section between the light-emitting section 7 and the ferrule 6). In this case, there is a risk that a laser beam having an output level which is harmful to humans directly enters an eye of a user when the user opens a cover (a hood in the case of an automobile) of a housing in which the headlamp 1 is housed.

Even if the laser beam-irradiated surface 7a is still not appropriately irradiated with the laser beams due to, e.g., an impact on the headlamp 1 although the laser beam-irradiated surface 7a and the emission end sections 5a are disposed in close proximity to each other, the provision of the light-blocking section 62 makes it possible to surely prevent the laser beams from leaking out from the hollow section 8a. Also, even if the laser beam-irradiated surface 7a and the emission end sections 5a are away from each other, the provision of the light-blocking section 62 makes it possible to prevent the laser beams from being emitted from the space enclosed by the light-blocking section 62, i.e., from leaking out from the hollow section 8a to the outside. The light-blocking section 62 is not necessarily required, provided that intended is to prevent at least the emission of the laser beams toward the front of the headlamp 1.

In FIG. 15, the light-blocking section 62 is provided for preventing the laser beams from leaking out from the hollow section 8a particularly in a direction toward the outside the reflection mirror 8 (i.e., in a direction other than the light irradiation direction). However, the light-blocking section 62 is not limited to the arrangement but may be provided for preventing the laser beams from being emitted in the light irradiation direction.

That is, in a case where the light-emitting section 7 (the laser beam-irradiated surface 7a) is provided inside the reflection mirror 8 as illustrated in FIG. 2, the light-blocking section 62 may be provided so as to cover at least the vicinity of those optical paths of the laser beams which are formed between the laser beam-irradiated surface 7a and the emission end sections 5a. In the case of FIG. 2, the light-blocking section 62 forms at least the enclosed space which encloses the laser beam-irradiated surface 7a and the ferrule 6, and the light-blocking section 62 has, e.g., a tube-like shape. A material for the light-blocking section 62 is preferably one which blocks the wavelength of the laser beams and a wavelength close thereto, and allows the light emitted from the light-emitting section 7 to pass through.

In a case where the light-blocking section 62 is thus provided inside the reflection mirror 8, the light-blocking section 62 makes it possible to prevent the laser beams from propagating through the space enclosed by the reflection mirror 8 and the transparent plate 9 so as to be emitted via the opening of the reflection mirror 8.

In FIGS. 14 and 15, the laser beam-irradiated surface 7a and the aperture plane of the hollow section 8a have substantially the same size. However, the aperture plane may be smaller than the laser beam-irradiated surface 7a. In this case, it may be arranged such that the peripheral part of the laser beam-irradiated surface 7a is directly connected with the reflection mirror 8 so as to be held by the reflection mirror 8.

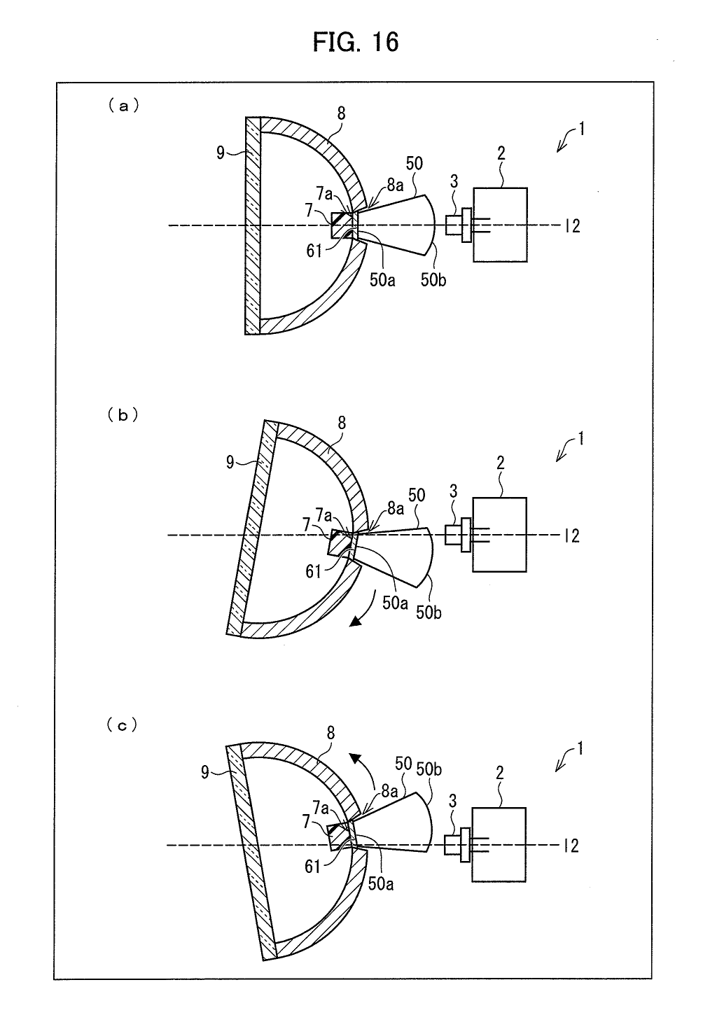

An arrangement in which the sectorial light guide section 50 described in the second embodiment is used instead of the optical fiber 5 also makes it possible to realize the headlamp 1 of the present embodiment, as illustrated in FIG. 16. As illustrated in FIG. 16, the light emitting surface 50a of the sectorial light guide section 50 is inserted into the hollow section 8a, and the light emitting surface 50a is in close proximity to the laser beam-irradiated surface 7a of the light-emitting section 7 via the heat-releasing member 61. This makes it possible to realize a headlamp 1 with a high level of safety, as is the case with the headlamps 1 illustrated in FIGS. 14 and 15.

Although FIG. 16 does not illustrate the light-blocking section 62, the light-blocking section 62 may be provided so that, e.g., the light-blocking section 62 and the reflection mirror 8 form an enclosed space which encloses the sectorial light guide section 50. Further, in the arrangement illustrated in FIG. 10, the light-blocking section 62 may be provided so as to cover the vicinity of the laser beam-irradiated surface 7a and the light emitting surface 50a.

Further, (a) of FIG. 16 shows that the optical axis direction of the headlamp 1 matches the direction along the reference line 12 (matches the reference direction), and accordingly, the light is emitted toward the right front of the headlamp 1, i.e., in the predetermined direction. (b) of FIG. 16 shows that the headlamp 1 is maneuvered to face upward from the reference line 12. (c) of FIG. 16 shows that the headlamp 1 is maneuvered to face downward from the reference line 12. Since these cases are the same as those illustrated in (a) through (c) of FIG. 11, the following omits descriptions of these cases.

### Fifth Embodiment

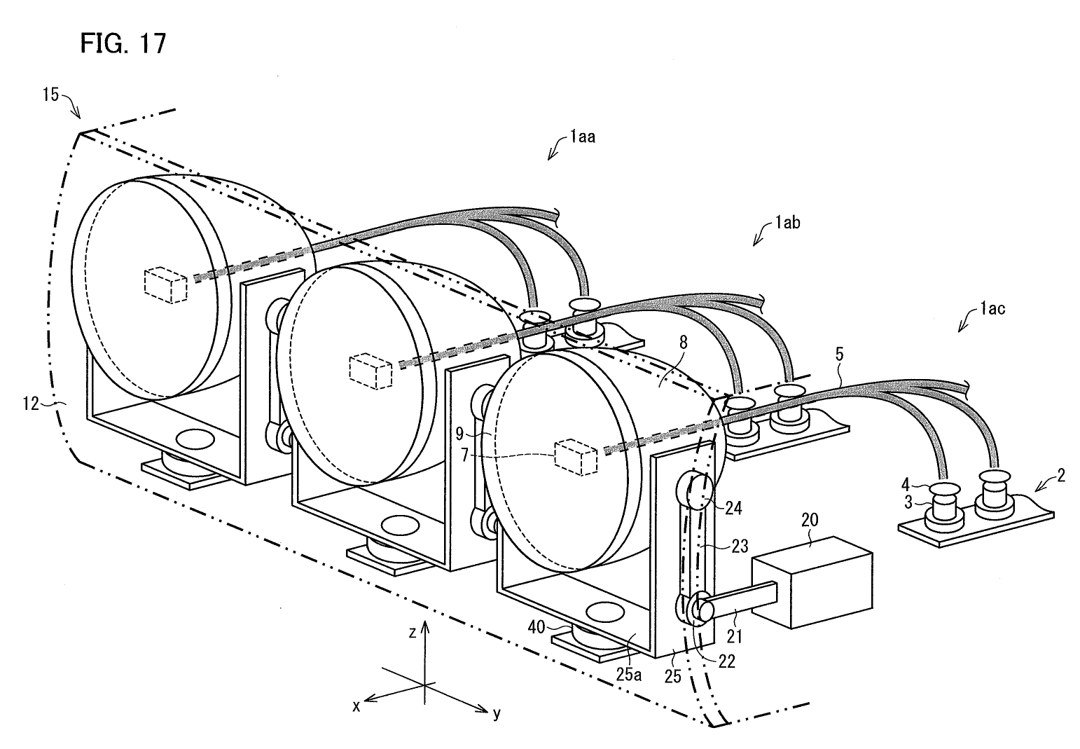

The following describes another embodiment of the present invention, with reference to FIG. 17. Members which are the same as those of the first through fourth embodiments are given common reference signs, and the following omits descriptions of such members. The present embodiment deals with a case where headlamps 1a one of which is illustrated in FIG. 12 constitute one headlamp 15. FIG. 17 is a perspective view illustrating a schematic arrangement of the headlamp 15 of the present embodiment.

FIG. 17 shows that the headlamp 15 is arranged such that three headlamps 1a are horizontally arranged in a line, and a lens 12 is provided so as to cover all the openings of reflection mirror 8 of the three headlamps 1a. Note that the three headlamps 1a are also referred to as headlamps 1aa, 1ab, and 1ac as illustrated in FIG. 17, respectively.

The number of headlamps 1a in the headlamp 15 is not limited to three but may be two or more. The headlamps 1a may share one laser diode array 2. In other words, the entrance end sections 5b of the optical fiber 5 of each of the headlamps 1a may be connected with one laser diode array 2. Further, it may be arranged such that a plurality of headlamps 1 one of which is illustrated in FIG. 2 are provided in the headlamp 15, instead of the headlamps 1a. That is, the headlamp 15 of the present embodiment includes a plurality of combinations each of which is made up of at least the light-emitting section 7, the reflection mirror 8, and the first maneuvering section 20. This makes it possible to realize the headlamp 15 including the plurality of combinations which make it possible to improve responsivity to the optical axis adjustment.

In FIG. 17, the headlamp 15 includes the light-emitting section 7, the reflection mirror 8, the first maneuvering section 20, and also the second maneuvering section 40. That is, the headlamp 15 includes a plurality of combinations each of which is made up of the light-emitting section 7, the reflection mirror 8, the first maneuvering section 20, and the second maneuvering section 40. In this case, the optical axis adjustment can be carried out in accordance not only with an up-and-down inclination of a vehicle but also with a lateral inclination of the vehicle.

The maneuver control section 323 illustrated in FIG. 8 may control the first maneuvering section 20 and the second maneuvering section 40 which are included in each of the plurality of combinations, in such a manner that the plurality of combinations are separately controlled. In this case, the maneuver control section 323 may be arranged to control each of the first maneuvering sections 20 and each of the second maneuvering sections 40, depending on whether the headlamp 15 serves as a passing headlamp or a driving headlamp (i.e., depending on an irradiation function of the headlamp 15).

Assume, for example, that in a case where the headlamp 15 is OFF, all the openings of the reflection mirrors 8 of the three headlamps 1a face in a direction perpendicular to an emitting surface of the lens 12 (i.e., in an “x” direction in FIG. 17).

In a case where the headlamp 15 is ON and serves as a passing headlamp, the maneuver control section 323 maneuvers (i) the reflection mirror 8 of the central headlamp 1ab in the three headlamps 1a and (ii) the reflection mirror 8 of the headlamp 1a which is closest to a center of a road among the three headlamps 1a (the headlamp 1aa in this case), by controlling respective first maneuvering sections 20 of the headlamps 1ab and 1aa, so that the reflection mirrors 8 face slightly downward from a horizontal direction (i.e., light irradiation direction in a case where the headlamp 15 serves as a driving headlamp). Further, the maneuver control section 323 maneuvers the reflection mirror 8 of the headlamp 1a which is farthest from the center of the road among the three headlamps 1a (the headlamp 1ac in this case), by controlling the first maneuvering section 20 of the headlamp 1ac, so that the reflection mirror 8 faces slightly upward from the horizontal direction. Further, the maneuver control section 323 controls respective second maneuvering sections 40 of the headlamp 1aa and 1ac so that the reflection mirrors 8 face away from the central headlamp 1ab.

That is, the first maneuvering sections 20 of the headlamps 1aa and 1ab maneuver the reflection mirrors 8 of the headlamps 1aa and 1ab by a first predetermined angle in a “−z” direction from the horizontal direction. The first maneuvering section 20 of the headlamp 1ac maneuvers the reflection mirror 8 of the headlamp 1ac by the first predetermined angle in a “+z” direction from the horizontal direction. Further, the second maneuvering section 40 of the headlamp 1aa maneuvers the reflection mirror 8 of the headlamp 1aa by a second predetermined angle in a “−y” direction from the X-axis. The second maneuvering section 40 of the headlamp 1ac maneuvers the reflection mirror 8 of the headlamp 1ac by the second predetermined angle in a “+y” direction from the X-axis. The first and second predetermined angles are determined so as to satisfy those irradiation ranges of a passing headlamp which are stipulated under the Road Trucking Vehicle Law. The first and second predetermined angles are stored in the storage section 33.

As is the case with the first embodiment, according to an instruction from the corrected value calculation section 322, the maneuver control section 323 then controls the first maneuvering sections 20 and the second maneuvering sections 40 in accordance with a posture of a vehicle having the headlamp 15. Thus, the reflection mirrors 8 of the headlamps 1aa through 1ac are maneuvered so that respective optical axis directions of the headlamps 1aa through 1ac match the predetermined directions.

In a case where the headlamp 15 is ON and serves as a driving headlamp, the maneuver control section 323 does not maneuver any of the reflection mirrors 8 of the three headlamps 1aa through 1ac (the directions of the reflection mirrors 8 of the headlamps 1a in a case where the headlamp 15 is OFF are maintained). Subsequently, the maneuver control section 323 maneuvers the reflection mirrors 8 in accordance with an instruction from the corrected value calculation section 322 so that the respective optical axis directions of the headlamps 1a match the predetermined directions, as described above.

In a case where the headlamp 15 thus includes the plurality of combinations each including the first maneuvering section 20 and the second maneuvering section 40, the optical axis adjustment can be carried out in accordance with a posture of a vehicle after the headlamps 1a are appropriately maneuvered in accordance with any one of the irradiation functions of the headlamp 15, i.e., the function of a passing headlamp and the function of a driving headlamp. Note that it is possible to at least maneuver the reflection mirrors 8 up-and-down in accordance with any one of the irradiation functions, provided that the headlamp 15 includes a plurality of combinations each including at least the first maneuvering section 20.

The irradiation functions are not limited to the function of a passing headlamp and the function of a driving headlamp. That is, in a case where a plurality of irradiation functions are defined by an illuminating device, the directions of the reflection mirrors 8 in the illuminating device may be appropriately adjusted in accordance with the plurality of irradiation functions when the illuminating device is turned on. Further, it may be arranged such that only either the first maneuvering section 20 or the second maneuvering section 40 is controlled in any headlamp 1a independently of other headlamps 1a, in accordance with any one of the plurality of irradiation functions.

[Different Aspects of Present Invention]

The present invention can also be expressed as below.

A vehicle headlamp of the present invention is preferably arranged such that the first maneuvering section maneuvers at least the reflection mirror in an up-and-down direction.

The arrangement makes it possible to surely carry out legally-stipulated optical axis up-and-down adjustment. This makes it possible to secure traffic safety. For example, it is possible to prevent a driver in an oncoming vehicle from being dazzled when passing each other.

Further, the vehicle headlamp of the present invention is preferably arranged such that the first maneuvering section is realized by using an ultrasonic motor.

The arrangement allows the first maneuvering section to have such characteristics of an ultrasonic motor that: it is possible to obtain a high torque, with slow operation; it is possible to realize a high holding force in a non-energized state; it is possible to downsize the first maneuvering section; etc. This allows the first maneuvering section to fulfill a function of an actuator for optical axis adjustment.

Further, the vehicle headlamp of the present invention preferably further includes a second maneuvering section for maneuvering at least the reflection mirror in a lateral direction so as to move the optical axis direction of the light reflected by the reflection mirror to the predetermined direction.

The arrangement makes it possible to maneuver the reflection mirror not only in the up-and-down direction but also in the lateral direction. This makes it possible to carry out optical axis adjustment in accordance with a lateral inclination of a vehicle. This makes it possible to carry out optical axis adjustment so that the legal stipulation is met and the headlamp irradiates a position that a driver sees.

Further, the vehicle headlamp of the present invention is preferably arranged such that the second maneuvering section is realized by using an ultrasonic motor.

The arrangement allows the second maneuvering section to have such characteristics of an ultrasonic motor that: it is possible to obtain a high torque, with slow operation; it is possible to realize a high holding force in a non-energized state; it is possible to downsize the second maneuvering section; etc. This allows the second maneuvering section to fulfill a function of an actuator for optical axis adjustment.

Further, the vehicle headlamp of the present invention preferably further includes a light guide section for (i) receiving the excitation light emitted from the excitation light source and (ii) emitting, toward the light-emitting section, the excitation light thus received, the excitation light source being provided outside the reflection mirror.

According to the arrangement, the vehicle headlamp includes a light guide section for (i) receiving the excitation light emitted from the excitation light source and (ii) emitting, toward the light-emitting section, the excitation light thus received. This makes it possible to provide the excitation light source and the light-emitting section at a sufficient distance. That is, employment of the light guide section makes it possible to provide the excitation light source outside the reflection mirror.

By providing the excitation light source outside the reflection mirror, the first maneuvering section does not have to maneuver the reflection mirror and the excitation light source together, in optical axis adjustment. This makes it possible to further downsize the maneuvering object to be maneuvered, and therefore reduce a weight thereof. This allows an maneuvering object which is maneuvered in optical axis adjustment, to have a further improved responsivity to the optical axis adjustment, as compared to conventional headlamps.

Further, the vehicle headlamp of the present invention is preferably arranged such that the light guide section has flexibility.

The arrangement allows the excitation light source not to be maneuvered in response to the movement of the reflection mirror caused by the first maneuvering section.

Further, the vehicle headlamp of the present invention is preferably arranged such that: the light-emitting section includes a light receiving surface for receiving the excitation light emitted from the light guide section; the light guide section is fixed to the reflection mirror so as to be maneuvered together with the reflection mirror; the light guide section has an incident surface for receiving the excitation light emitted from the excitation light source; and the incident surface has a cross-sectional shape which makes it possible to locate the excitation light source in any one of positions which are at an equal distance from a center of the light receiving surface.

According to the arrangement, the light guide section is fixed to the reflection mirror so as to be maneuvered together with the reflection mirror, and the incident surface of the light guide section has a cross-sectional shape which makes it possible to locate the excitation light source in any one of positions which are at an equal distance from a center of the light receiving surface. This makes it possible to keep substantially the constant distance between the excitation light source and the reflection mirror whichever direction the first maneuvering section maneuvers reflection mirror.

Thus, the vehicle headlamp includes the light guide section which is fixed to the reflection mirror so as to be maneuvered together with the reflection mirror and which has the incident surface above. This makes it possible to maintain the optical axis direction in the predetermined direction. As a result, optical axis adjustment can be carried out appropriately.

Further, the vehicle headlamp of the present invention is preferably arranged such that the light-emitting section includes a light receiving surface for receiving the excitation light emitted from the excitation light source; the light-emitting section is provided so that the light receiving surface is located outside of a space formed by the reflection mirror and an opening of the reflection mirror.

According to the arrangement, the light receiving surface is provided outside of the space formed by the reflection mirror and an opening of the reflection mirror (space enclosed by the reflection mirror and the opening thereof). Accordingly, no excitation light (particularly, high-power excitation light such as a laser beam) is received by the light receiving surface inside the space. This makes it possible to prevent excitation light having an output level which is harmful to humans from propagating through the space so as to leak out to the outside the space (at least in the light irradiation direction of the light-emitting section).

Further, the arrangement makes it possible to prevent the excitation light from directly leaking out at least in the light irradiation direction even if the light receiving surface is not irradiated with the excitation light in a case where, e.g., the vehicle headlamp is subjected to an impact of some sort.

By thus providing the light-emitting section so that the light receiving surface is located outside the space, it is possible to realize a vehicle headlamp with a high level of safety.

Further, the vehicle headlamp of the present invention preferably further includes: a light guide section for (i) receiving the excitation light emitted from the excitation light source and (ii) emitting, toward the light-emitting section, the excitation light thus received, the light-emitting section including a light receiving surface for receiving the excitation light emitted from the light guide section, the light guide section including an emission end section for emitting, toward the light-emitting section, the excitation light thus received from the excitation light source; and a light-blocking section in a vicinity of the light receiving surface and the emission end section, the light-blocking section blocking at least one of (i) excitation light emitted from the emission end section but not irradiating the light receiving surface and (ii) excitation light emitted from the emission end section and then reflected from the light receiving surface.

According to the arrangement, the vehicle headlamp includes the light-blocking section. This makes it possible to surely prevent the excitation light from leaking out to the outside of the light-blocking section in a case where the light receiving surface is not appropriately irradiated with the excitation light due to, e.g., an impact on the vehicle headlamp. In the case of the arrangement, the excitation light does not propagate through the space formed by the reflection mirror and the opening thereof. This makes it possible to prevent the emission of the excitation light in the light irradiation direction, and also prevent the leakage of the excitation light in other directions.

Further, the vehicle headlamp of the present invention preferably further includes a light guide section for (i) receiving the excitation light emitted from the excitation light source and (ii) emitting, toward the light-emitting section, the excitation light thus received, the light-emitting section including a light receiving surface for receiving the excitation light emitted from the light guide section, the light guide section including an emission end section for emitting, toward the light-emitting section, the excitation light thus received from the excitation light source, and the light receiving surface and the emission end section being in close proximity to each other.

According to the arrangement, the light receiving surface of the light-emitting section and the emission end section of the light guide section are in close proximity to each other. Accordingly, the excitation light (particularly, high-power excitation light) does not propagate through the space formed by the reflection mirror and the opening thereof. This makes it possible to prevent such a problem that in a case where, e.g., the vehicle headlamp is subjected to an impact of some sort, the light receiving surface is not irradiated with excitation light having an output level which is harmful to humans so that the excitation light directly leaks out to the outside of the vehicle headlamp. This makes it possible to realize a vehicle headlamp with a high level of safety.

Further, the vehicle headlamp of the present invention is preferably arranged such that: the reflection mirror includes a hollow section into which the emission end section is inserted; the hollow section includes a heat-releasing member for releasing heat which is generated from the light-emitting section by irradiating, with the excitation light, the light-emitting section; and the light receiving surface and the emission end section are in close proximity to each other with the heat-releasing member disposed to intervene the light receiving surface and the emission end section.

In a case where the light receiving surface and the emission end section are in close proximity to each other, an amount of heat generation from the light-emitting section increases accordingly (the light-emitting section has a higher temperature). For this reason, there is a risk that the light-emitting section is rapidly deteriorated.

According to the arrangement, the heat-releasing member is provided in the hollow section of the reflection mirror, and the emission end section and the light receiving surface are in close proximity to each other with the heat-releasing member disposed to intervene the light receiving surface and the emission end section. This makes it possible to release, into the reflection mirror via the heat-releasing member, the heat which is generated from the light-emitting section by irradiating the light receiving surface with the excitation light. This makes it possible to increase a life of the light-emitting section.

Thus, even if the light receiving surface and the emission end section are disposed in close proximity to each other in order to secure safety, it is still possible to suppress a temperature rise of the light-emitting section. That is, it is possible to realize a vehicle headlamp with a high level of safety and a long life.

The vehicle headlamp of the present invention preferably includes a plurality of combinations each of which includes the light-emitting section, the reflection mirror, and the first maneuvering section.

According to the arrangement, it is possible to realize a vehicle headlamp including the plurality of combinations which make it possible to improve responsivity to the optical axis adjustment.

The present invention can also be expressed as below.

That is, the vehicle headlamp of the present invention is arranged such that an ultracompact laser headlight (headlamp) system and an ultrasonic motor are combined so that the optical axis direction is maintained in the predetermined direction.

Further, the vehicle headlamp of the present invention preferably includes a laser light source having a high luminous flux and a high luminance.

Further, the vehicle headlamp of the present invention is preferably arranged such that by taking advantage of a high optical connection efficiency of a laser beam and a light guide member, a fluorescent light-emitting section and an excitation light source are spatially separated, and the excitation light is transmitted from the excitation light source to the fluorescent light-emitting section via the light guide member.

Further, the vehicle headlamp of the present invention preferably employs an ultrasonic motor as its drive source. Alternatively, a stepping motor may be employed.

[Supplemental]

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

For example, a high-power LED may be employed as the excitation light source. In this case, a light-emitting device which emits white light can be realized by combining an LED which emits light having a wavelength of 450 nm (blue) with (i) a yellow fluorescent substance, or (ii) a green fluorescent substance and a red fluorescent substance.

Further, a solid laser other than the laser diode may be employed as the excitation light source. However, the laser diode is more preferable than the solid laser because the laser diode makes it possible to downsize the excitation light source.

The opening of the reflection mirror 8 has a circular shape as viewed from the right front. However, the shape is not limited to this but may be a shape such as an elliptical shape and a rectangular shape, provided that the light reflected by the reflection mirror 8 is efficiently emitted outside.

The first embodiment deals with the arrangement in which the first maneuvering section 20 (linear actuator) is employed as an optical axis adjustment mechanism. However, the present invention is not limited to this. The second maneuvering section 40 (ultrasonic motor) may be employed instead of the first maneuvering section 20. In this case, the second maneuvering section 40 is provided so that the motor shaft section 404 is located at the shaft of the second shaft section 24. That is, the second maneuvering section 40 is provided so that the motor shaft section 404 is perpendicular to the optical axis direction and to the up-and-down direction, and the that the motor shaft section 404 faces the third shaft section 26. The second maneuvering section 40 is fixed by, e.g., a bar-like or tube-like member extended from the housing 10. The arrangement in which the second maneuvering section 40 is employed as an optical axis adjustment mechanism instead of the first maneuvering section 20 also makes it possible to produce an effect equivalent to that of the first embodiment.

Instead of the ultrasonic motor, a stepping motor may be employed which has a simple circuit configuration and is suitable for accurate positioning control.

The third and fifth embodiments deal with the arrangement in which the optical fiber 5 is provided. However, the present invention is not limited to this. As is the case with the second embodiment, the sectorial light guide section 50 may be employed instead of the optical fiber 5. The first to fifth embodiments may be such that in order that the laser beam-irradiated surface 7a of the light-emitting section 7 is properly irradiated with the laser beam from the laser diode 3, the laser diode 3 and the light-emitting section 7 are integrated and sealed, or an optical system such as a reflector is provided (in these cases, the optical fiber 5 and the sectorial light guide section 50 are not required). In this case, each of the first maneuvering section 20 and the second maneuvering section 40 maneuvers the reflection mirror 8, and the laser diode 3 and/or the reflector together.

### INDUSTRIAL APPLICABILITY

A vehicle headlamp (illumination device) of the present invention allows an maneuvering object which is maneuvered in optical axis adjustment, to have an improved responsivity to the optical axis adjustment. The vehicle headlamp of the present invention is applicable to a headlamp for not only an automobile but also a vehicle or moving object such as a human, a vessel, an airplane, a submersible vessel, or a rocket.

### REFERENCE SIGNS LIST

1, 1a, 1aa, 1ab, 1ac, 15
Headlamp (vehicle headlamp, illumination device)
2 Laser diode array (excitation light source)
3 Laser, diode (excitation light source)
5 Optical fiber (light guide section)
5a Emission end section
7 Light-emitting section
7a Laser beam-irradiated surface (light receiving surface)
8 Reflection mirror
8a Hollow section
20 First maneuvering section
40 Second maneuvering section
50 Sectorial light guide section (light guide section)
50b Light incident surface (incident surface)
61 Heat-releasing member
62 Light-blocking section

1. A vehicle headlamp comprising:
an excitation light source for emitting excitation light;
a light-emitting section for receiving the excitation light emitted from the excitation light source, and emitting light by being exited by the excitation light;
a reflection mirror for reflecting the light emitted from the light-emitting section so as to form a bundle of rays which travel within a predetermined solid angle; and
a first maneuvering section for maneuvering at least the reflection mirror so as to move an optical axis direction of the light reflected by the reflection mirror to a predetermined direction.

2. The vehicle headlamp as set forth in claim 1, wherein the first maneuvering section maneuvers at least the reflection mirror in an up-and-down direction.

3. The vehicle headlamp as set forth in claim 1, wherein the first maneuvering section is realized by using an ultrasonic motor.

4. The vehicle headlamp as set forth in claim 2, further comprising a second maneuvering section for maneuvering at least the reflection mirror in a lateral direction so as to move the optical axis direction of the light reflected by the reflection mirror to the predetermined direction.

5. The vehicle headlamp as set forth in claim 4, wherein the second maneuvering section is realized by using an ultrasonic motor.

6. The vehicle headlamp as set forth in claim 1, further comprising a light guide section for (i) receiving the excitation light emitted from the excitation light source and (ii) emitting, toward the light-emitting section, the excitation light thus received,
the excitation light source being provided outside the reflection mirror.

7. The vehicle headlamp as set forth in claim 6, wherein the light guide section has flexibility.

8. The vehicle headlamp as set forth in claim 6, wherein:
the light-emitting section includes a light receiving surface for receiving the excitation light emitted from the light guide section;
the light guide section is fixed to the reflection mirror so as to be maneuvered together with the reflection mirror;
the light guide section has an incident surface for receiving the excitation light emitted from the excitation light source; and
the incident surface has a cross-sectional shape which makes it possible to locate the excitation light source in any one of positions which are at an equal distance from a center of the light receiving surface.

9. The vehicle headlamp as set forth in claim 1, wherein:
the light-emitting section includes a light receiving surface for receiving the excitation light emitted from the excitation light source;
the light-emitting section is provided so that the light receiving surface is located outside of a space formed by the reflection mirror and an opening of the reflection mirror.

10. The vehicle headlamp as set forth in claim 1, further comprising:
a light guide section for (i) receiving the excitation light emitted from the excitation light source and (ii) emitting, toward the light-emitting section, the excitation light thus received,
the light-emitting section including a light receiving surface for receiving the excitation light emitted from the light guide section,
the light guide section including an emission end section for emitting, toward the light-emitting section, the excitation light thus received from the excitation light source; and
a light-blocking section in a vicinity of the light receiving surface and the emission end section, the light-blocking section blocking at least one of (i) excitation light emitted from the emission end section but not irradiating the light receiving surface and (ii) excitation light emitted from the emission end section and then reflected from the light receiving surface.

11. The vehicle headlamp as set forth in claim 1, further comprising a light guide section for (i) receiving the excitation light emitted from the excitation light source and (ii) emitting, toward the light-emitting section, the excitation light thus received,
the light-emitting section including a light receiving surface for receiving the excitation light emitted from the light guide section,
the light guide section including an emission end section for emitting, toward the light-emitting section, the excitation light thus received from the excitation light source, and
the light receiving surface and the emission end section being in close proximity to each other.

12. The vehicle headlamp as set forth in claim 11, wherein:
the reflection mirror includes a hollow section into which the emission end section is inserted;
the hollow section includes a heat-releasing member for releasing heat which is generated from the light-emitting section by irradiating, with the excitation light, the light-emitting section; and
the light receiving surface and the emission end section are in close proximity to each other with the heat-releasing member disposed to intervene the light receiving surface and the emission end section.

13. The vehicle headlamp as set forth in claim 1, comprising a plurality of combinations each of which includes the light-emitting section, the reflection mirror, and the first maneuvering section.

14. An illumination device comprising:
an excitation light source for emitting excitation light;
a light-emitting section for receiving the excitation light emitted from the excitation light source, and emitting light by being exited by the excitation light;
a reflection mirror for reflecting the light emitted from the light-emitting section so as to form a bundle of rays which travel within a predetermined solid angle; and
a first maneuvering section for maneuvering at least the reflection mirror so as to move an optical axis direction of the light reflected by the reflection mirror to a predetermined direction.
